(19) United States
(12) Patent Application Publication
(10) Pub. No.: US 2026/0020002 A1
(43) Pub. Date: Jan. 15, 2026

(54) CONFIGURATION OF FRAME FORMAT FOR EXTENDED RANGE TRANSMISSION

(71) Applicant: LG ELECTRONICS INC., Seoul (KR)

(72) Inventors: Dongguk LIM, Seoul (KR); Jinsoo CHOI, Seoul (KR); Eunsung PARK, Seoul (KR); Insik JUNG, Seoul (KR)

(73) Assignee: LG ELECTRONICS INC., Seoul (KR)

(21) Appl. No.: 19/334,560

(22) Filed: Sep. 19, 2025

Related U.S. Application Data
(63) Continuation of application No. PCT/KR2025/008788, filed on Jun. 24, 2025.
(60) Provisional application No. 63/671,696, filed on Jul. 15, 2024.
(60) Provisional application No. 63/671,697, filed on Jul. 15, 2024.
(60) Provisional application No. 63/671,702, filed on Jul. 15, 2024.

(30) Foreign Application Priority Data
Aug. 9, 2024 (KR) 10-2024-0106951

(51) Int. Cl. H04W 72/044; H04L 5/00

(52) U.S. Cl. CPC H04W 72/044; H04L 5/0044

(57) ABSTRACT

This disclosure may propose a method for transmitting/receiving a physical protocol data unit (PPDU) with an improved structure and a device related thereto. A station (STA) related to this disclosure can generate an ELR PPDU that includes a data field. The ELR PPDU may include a legacy signal (L-SIG) field containing information related to the length of the ELR PPDU and a universal signal (U-SIG) field containing information for interpreting the ELR PPDU. For example, the L-SIG field, the RL-SIG field, and the U-SIG field may be generated based on the first subcarrier frequency spacing. For example, the ELR PPDU may further include a Short Training Field (STF), a Long Training Field (LTF), an ELR Signal (ELR-SIG) field, and a data field. For example, the STF, the LTF, the ELR-SIG field, and the data field may be generated based on the second subcarrier frequency spacing.

### CROSS-REFERENCE TO RELATED APPLICATIONS

This application is a continuation of International Application No. PCT/KR2025/008788, filed on Jun. 24, 2025, which claims the benefit of earlier filing date and right of priority to Korean Application No. 10-2024-0106951, filed on Aug. 9, 2024, and also claims the benefit of U.S. Provisional Application No(s). 63/671,696, 63/671,697, and 63/671,702, all filed on Jul. 15, 2024, the contents of which are all incorporated by reference herein in their entirety.

### TECHNICAL FIELD

The present disclosure relates to a wireless LAN system, and more specifically, to a method and device for improving the structure of a frame format related to long-range communication in a wireless LAN system.

### BACKGROUND

Wireless local area networks (WLANs) have been improved in various ways. For example, the Extremely High Throughput (EHT) standard can utilize newly proposed increased bandwidth, an improved PHY layer protocol data unit (PPDU) structure, improved sequences, and a Hybrid Automatic Repeat Request (HARQ) technique.

For example, a new standard that further improves the EHT standard is called the Ultra High Reliability (UHR) standard. The UHR standard may also be designated as IEEE 802.11bn or Wi-Fi 8. For example, the UHR standard can propose technical features that improve data rates even at low signal-to-interference plus noise ratio (SINR) levels. Furthermore, the UHR standard can propose technical features that minimize latency and jitter even in scenarios with mobility and overlapping BSSs. Furthermore, the UHR standard can propose technical features for wireless medium reuse.

For example, the UHR standard can propose a new frame or PPDU format. For example, a PPDU format for solving problems caused by imbalance in transmission power between uplink and downlink can be discussed in a UHR system.

### SUMMARY

In a wireless LAN system, various STAs, including access points (APs) and non-AP STAs (stations), can operate. Typically, the TX power of an AP is greater than that of a non-AP STA. This difference in TX power can lead to a difference between the downlink and uplink signal transmission ranges associated with a wireless LAN system.

To overcome this signal transmission range discrepancy, a new physical protocol data unit (PPDU) structure can be proposed. These PPDUs can incorporate a frame structure designed to increase signal transmission range. For example, improving signal transmission range may require improved frequency mapping techniques, such as in the PPDU data field.

Furthermore, to ensure accurate decoding of the PPDU data field, a new signal field including information for PPDU interpretation needs to be defined. This newly defined signal field should incorporate various technical features for long-distance communication. Additionally, the newly defined signal field's position among existing fields (e.g., LTF, STF, Legacy Signal, etc.) should be discussed. Furthermore, various technical features applicable to new PPDUs for long-distance communications should be discussed.

The present specification (present disclosure) may propose a method for transmitting/receiving a physical protocol data unit (PPDU) with an improved structure and a related device.

Among various examples of the present specification, a PPDU capable of increasing transmission range may be related to long range (LR), extended range (ER), and enhanced long range (ELR) communications. A station (STA) related to the present specification may generate an ELR PPDU including a data field. For example, the bandwidth of the ELR PPDU may be 20 MHz. For example, the data field may be transmitted via four 52-tone resource units (RUs) duplicated in the frequency domain. For example, the ELR PPDU of the present specification may further include an LTF signal/field.

The ELR PPDU may include a legacy signal (L-SIG) field including information related to the length of the ELR PPDU and a universal signal (U-SIG) field including information for interpreting the ELR PPDU.

For example, the L-SIG field, the RL-SIG field, and the U-SIG field may be generated based on a first subcarrier frequency spacing.

For example, the ELR PPDU may further include a Short Training Field (STF), a Long Training Field (LTF), an ELR Signal (ELR-SIG) field, and a data field.

For example, the STF, the LTF, the ELR-SIG field, and the data field may be generated based on a second subcarrier frequency spacing.

For example, the ELR-SIG field may be transmitted via four 52-tone resource units (RUs) duplicated in the frequency domain in units of 52-tone resource units.

An example of the present specification proposes an improved structure for an ELR PPDU. For example, an improved frequency mapping technique is proposed, in which RUs of a specific size are duplicated/repeated. This can increase the transmission range of the PPDU. For example, the frequency mapping technique for specific fields within the PPDU can be improved. For example, data bits for the data field can be duplicated in units of RUs of a specific size, and improved phase rotation can be applied to multiple duplicated RUs.

An example of the present specification proposes a new signal field that includes various information related to the ELR PPDU and/or ELR communication. This signal field may have various names, such as the ELR-SIG field. The ELR-SIG field may include a portion of the information contained in existing L-SIG, RL-SIG, and U-SIG fields. For example, the ELR-SIG field may be proposed in case the existing L-SIG, RL-SIG, and U-SIG fields are not successfully received by the receiving STA due to UL/DL power imbalance issues. To this end, the ELR-SIG field, unlike the existing L-SIG, RL-SIG, and U-SIG fields, can be duplicated in the frequency domain in units of a specific size of RU (e.g., 52-tone RU). For example, the ELR PPDU of the present specification includes the existing L-SIG, RL-SIG, and U-SIG fields, but there is no need to perform repetition operations in the time domain or duplication operations in the frequency domain for the fields. In other words, the ELR PPDU of the present specification proposes a technique that proposes the performance of ELR-SIG without increasing the overhead of the existing L-SIG, RL-SIG, and U-SIG fields.

For example, the ELR-SIG, similar to the ELR-Data field, can have the same OFDM numerology as the ELR-Data field because it is duplicated in the frequency domain. Additionally or alternatively, the ELR-SIG can be placed immediately after the STF/LTF included in the UHR PPDU to achieve the technical benefits of synchronization, channel estimation, and CFO achieved through the STF/LTF.

Furthermore, the ELR-SIG of the present specification can include various optimized fields related to the ELR PPDU, enabling ELR PPDU reception even in situations where the existing L-SIG, RL-SIG, and U-SIG fields are not duplicated.

### BRIEF DESCRIPTION OF THE DRAWINGS

FIG. 1 illustrates an example of a transmitting device and/or receiving device of the present specification.

FIG. 2 is a conceptual diagram illustrating the structure of a wireless local area network (WLAN).

FIG. 3 is a diagram illustrating a general link setup process.

FIG. 4 illustrates an embodiment of multi-link (ML).

FIG. 5 illustrates PPDUs transmitted/received by a STA of the present specification.

FIG. 6 is a diagram illustrating the layout of resource units (RUs) used for a 20 MHz PPDU.

FIG. 7 is a diagram illustrating the layout of resource units (RUs) used for a 40 MHz PPDU.

FIG. 8 is a diagram illustrating the layout of resource units (RUs) used for an 80 MHz PPDU.

FIG. 9 illustrates operations according to UL-MU.

FIG. 10 illustrates an example of channels used/supported/defined within the 2.4 GHz band.

FIG. 11 illustrates an example of channels used/supported/defined within the 5 GHz band.

FIG. 12 illustrates an example of channels used/supported/defined within the 6 GHz band.

FIG. 13 illustrates an example of a MAC frame header.

FIG. 14 illustrates a modified example of a transmitting device and/or receiving device according to the present specification.

FIG. 15 illustrates an example of a PPDU proposed in the present specification.

FIG. 16 illustrates an example of a legacy preamble according to the present specification.

FIG. 17 illustrates an example of multiple fields/subfields that may be included in an ELR preamble.

FIG. 18 illustrates frequency domain duplication applied to the ELR-SIG.

FIG. 19 illustrates an example of an ELR PPDU according to the present specification.

FIG. 20 is a diagram illustrating four 52-tone RUs included in an ELR PPDU.

FIG. 21 is an example of a procedure flowchart related to the present specification.

FIG. 22 is an example of a procedure flowchart related to the present specification.

### DETAILED DESCRIPTION

As used herein, “A or B” can mean “only A,” “only B,” or “both A and B.” Alternatively, “A or B” can be interpreted as “A and/or B.” For example, as used herein, “A, B or C” can mean “only A,” “only B,” “only C,” or “any combination of A, B, and C.”

As used herein, a slash (/) or a comma can mean “and/or.” For example, “A/B” can mean “A and/or B.” Accordingly, “A/B” can mean “only A,” “only B,” or “both A and B.” For example, “A, B, C” may mean “A, B, or C.”

In the present specification, “at least one of A and B” may mean “only A,” “only B,” or “both A and B.” Furthermore, in the present specification, the expressions “at least one of A or B” or “at least one of A and/or B” may be interpreted identically to “at least one of A and B.”

Furthermore, parentheses used herein may mean “for example.” Specifically, when “control information (UHR-Signal field)” is indicated, the “UHR-Signal field” may be suggested as an example of “control information.” In other words, the “control information” in the present specification is not limited to the “UHR-Signal field,” and the “UHR-Signal field” may be proposed as an example of “control information.” Furthermore, even when “control information (UHR-Signal field)” is indicated, the “UHR-Signal field” may be proposed as an example of “control information.”

Furthermore, “a/an” as used herein may mean “at least one” or “one or more.” Furthermore, terms ending in “(s)” may mean “at least one” or “one or more.”

Furthermore, the expressions “based on,” “on the basis of,” or “according to” used in the present specification mean “based at least in part on,” and do not mean “based solely on” a single element one.

Technical features individually described in a single drawing in the present specification may be implemented individually or simultaneously.

The following examples of the present specification may be applied to various wireless communication systems. For example, the following examples of the present specification may be applied to wireless local area network (WLAN) systems. For example, the present specification may be applied to the IEEE 802.11a/g/n/ac/ax/be/bn standards. Furthermore, the examples of the present specification may also be applied to the Ultra High Reliability (UHR) standard or next-generation WLAN standards that enhance IEEE 802.11bn. Additionally, examples of the present specification may be applied to mobile communication systems. For example, it may be applied to mobile communication systems based on Long Term Evolution (LTE) and its evolutions based on the 3rd Generation Partnership Project (3GPP) standards.

Hereinafter, to explain the technical features of the present specification, technical features to which the present specification can be applied will be described.

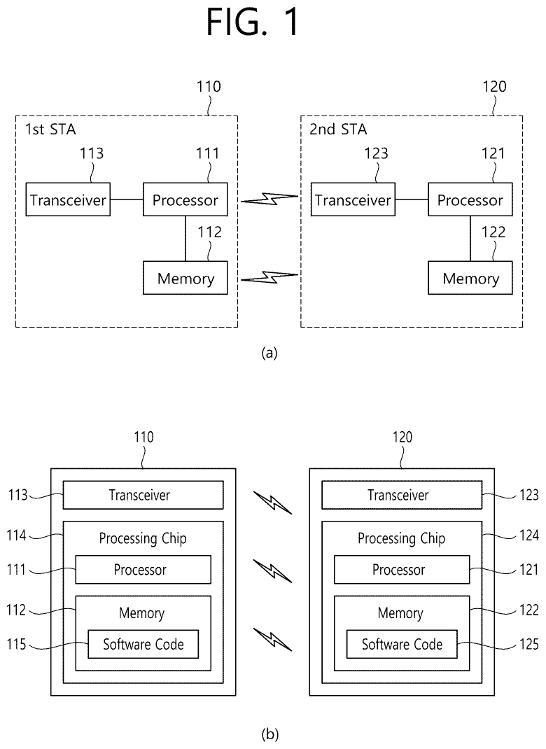

FIG. 1 illustrates an example of a transmitting device and/or receiving device of the present specification.

The example of FIG. 1 can perform various technical features described below. FIG. 1 relates to at least one STA (station). For example, the STAs (110, 120) of the present specification may also be referred to by various names, such as a mobile terminal, a wireless device, a wireless transmit/receive unit (WTRU), a user equipment (UE), a mobile station (MS), a mobile subscriber unit (MS), or simply a user. The STAs (110, 120) of the present specification may also be referred to by various names, such as a network, a base station, a Node-B, an access point (AP), a repeater, a router, or a relay. The STAs (110, 120) of the present specification may be referred to by various names, such as a receiving apparatus, a transmitting apparatus, a receiving STA, a transmitting STA, a receiving device, or a transmitting device.

For example, the STAs (110, 120) of the present specification may function as an access point (AP) or a non-AP. That is, the STAs (110, 120) of the present specification may perform the functions of an AP and/or a non-AP STA. In the present specification, an AP may also be referred to as an AP STA.

The STAs (110, 120) of the present specification may support various communication standards other than the IEEE 802.11 standard. For example, they may support communication standards based on the 3GPP standard (e.g., LTE, LTE-A, 5G NR standards). Furthermore, the STAs of the present specification may be implemented in various devices, such as mobile phones, vehicles, and personal computers. Additionally, the STA of the present specification can support communication for various communication services, such as voice calls, video calls, data communications, and autonomous driving (self-driving).

In the present specification, the STAs (110, 120) may include a medium access control (MAC) and a physical layer interface for wireless media that conforms to the IEEE 802.11 standard.

The STAs (110, 120) are described below based on sub-drawing (a) of FIG. 1.

The first STA (110) may include a processor (111), memory (112), and a transceiver (113). The illustrated processor, memory, and transceiver may be implemented as separate chips, or at least two blocks/functions may be implemented on a single chip.

The transceiver (113) of the first STA performs signal transmission and reception operations. Specifically, it can transmit and receive IEEE 802.11 packets (e.g., IEEE 802.11a/b/g/n/ac/ax/be, etc.).

For example, the first STA (110) can perform the intended operation of an AP. For example, the processor (111) of the AP can receive a signal via the transceiver (113), process the received signal, generate a transmission signal, and perform control for signal transmission. The memory (112) of the AP can store a signal received via the transceiver (113) (e.g., a received signal) and a signal to be transmitted via the transceiver (e.g., a transmitted signal).

For example, the second STA (120) can perform the intended operation of a non-AP STA. For example, the transceiver (123) of the non-AP can perform signal transmission and reception operations. Specifically, it can transmit and receive IEEE 802.11 packets (e.g., IEEE 802.11a/b/g/n/ac/ax/be, etc.).

For example, the processor (121) of the non-AP STA can receive signals via the transceiver (123), process the received signals, generate transmission signals, and perform control for signal transmission. The memory (122) of the non-AP STA can store signals received via the transceiver (123) (e.g., received signals) and signals to be transmitted via the transceiver (e.g., transmitted signals).

For example, the operations of a device designated as an AP in the following specification can be performed by the first STA (110) or the second STA (120). For example, if the first STA (110) is an AP, the operation of the device indicated as the AP is controlled by the processor (111) of the first STA (110), and a related signal may be transmitted or received through the transceiver (113) controlled by the processor (111) of the first STA (110). In addition, control information related to the operation of the AP or the transmission/reception signal of the AP may be stored in the memory (112) of the first STA (110). In addition, if the second STA (110) is an AP, the operation of the device indicated as the AP is controlled by the processor (121) of the second STA (120), and a related signal may be transmitted or received through the transceiver (123) controlled by the processor (121) of the second STA (120). In addition, control information related to the operation of the AP or the transmission/reception signals of the AP may be stored in the memory (122) of the second STA (110).

For example, the operation of a device indicated as a non-AP (or User-STA) in the following specification may be performed in the first STA (110) or the second STA (120). For example, if the second STA (120) is a non-AP, the operation of the device indicated as a non-AP may be controlled by the processor (121) of the second STA (120), and related signals may be transmitted or received through the transceiver (123) controlled by the processor (121) of the second STA (120). In addition, control information related to the operation of the non-AP or the transmission/reception signals of the AP may be stored in the memory (122) of the second STA (120). For example, if the first STA (110) is a non-AP, the operation of a device designated as a non-AP is controlled by the processor (111) of the first STA (110), and related signals may be transmitted or received through a transceiver (113) controlled by the processor (111) of the first STA (120). Furthermore, control information related to the operation of the non-AP or the transmission/reception signals of the AP may be stored in the memory (112) of the first STA (110).

In the following specifications, (transmitting/receiving) STA, first STA, second STA, STA1, STA2, AP, first AP, second AP, AP1, AP2, (transmitting/receiving) Terminal, (transmitting/receiving) device, (transmitting/receiving) apparatus, network, etc., may refer to the STA (110, 120) in FIG. 1. For example, devices indicated without specific drawing symbols as (transmitting/receiving) STA, First STA, Second STA, STA1, STA2, AP, First AP, Second AP, AP1, AP2, (transmit/receive) terminal, (transmit/receive) device, (transmit/receive) apparatus, network, etc., may also refer to the STA (110, 120) in FIG. 1. For example, in the following example, the operation of various STAs transmitting and receiving signals (e.g., PPDU) may be performed by the transceivers (113, 123) in FIG. 1. Additionally, in the following example, the actions of various STAs generating transmission/reception signals or performing data processing or calculations in advance for transmission/reception signals may be performed by the processor (111, 121) in FIG. 1. For example, an example of the operation of generating transmission/reception signals or performing data processing or calculations in advance for transmission/reception signals is: 1) determining/obtaining/configuring/calculating/decoding/encoding the bit information of the subfields (SIG, STF, LTF, Data) included in the PPDU; 2) determining/configuring/acquiring time resources or frequency resources (e.g., subcarrier resources) used for the subfields (SIG, STF, LTF, Data) included in the PPDU; 3) determining/configuring/acquiring specific sequences (e.g., pilot sequences, STF/LTF sequences, extra sequences applied to SIG) used for the subfields (SIG, STF, LTF, Data) included in the PPDU; 4) power control actions and/or power saving actions applied to STA, 5) actions related to determining/obtaining/configuring/calculating/decoding/encoding ACK signals. Additionally, in the following example, various information (e.g., information related to fields/subfields/control fields/parameters/power, etc.) used by various STAs for determining/acquiring/configuring/calculating/decoding/encoding transmission/reception signals may be stored in the memory (112, 122) shown in FIG. 1.

The device/STA of sub-drawing (a) of FIG. 1 described above can be modified as shown in sub-drawing (b) of FIG. 1. The STAs (110, 120) of the present specification will now be described based on sub-drawing (b) of FIG. 1.

For example, the transceivers (113, 123) illustrated in sub-drawing (b) of FIG. 1 can perform the same functions as the transceivers illustrated in sub-drawing (a) of FIG. 1 described above. For example, the processing chip (114, 124) illustrated in sub-drawing (b) of FIG. 1 may include a processor (111, 121) and a memory (112, 122). The processor (111, 121) and the memory (112, 122) illustrated in sub-drawing (b) of FIG. 1 may perform the same functions as the processor (111, 121) and the memory (112, 122) illustrated in sub-drawing (a) of FIG. 1 described above.

The mobile terminal, wireless device, Wireless Transmit/Receive Unit (WTRU), User Equipment (UE), Mobile Station (MS), Mobile Subscriber Unit, user, user STA, network, Base Station, Node-B, Access Point (AP), repeater, router, relay, receiving device, transmitting device, receiving STA, transmitting STA, receiving Device, transmitting Device, receiving Apparatus, and/or transmitting Apparatus described below may refer to the STA (110, 120) illustrated in the sub-drawings (a)/(b) of FIG. 1, or may refer to the processing chip (114, 124) illustrated in the sub-drawing (b) of FIG. 1. That is, the technical feature of the present specification may be performed in the STA (110, 120) illustrated in the sub-drawings (a)/(b) of FIG. 1, or may be performed only in the processing chip (114, 124) illustrated in the sub-drawings (b) of FIG. 1. For example, the technical feature that the transmitting STA transmits a control signal may be understood as a technical feature that the control signal generated in the processor (111, 121) illustrated in the sub-drawings (a)/(b) of FIG. 1 is transmitted through the transceiver (113, 123) illustrated in the sub-drawings (a)/(b) of FIG. 1. Alternatively, the technical feature that the transmitting STA transmits a control signal may be understood as a technical feature that the control signal to be transmitted to the transceiver (113, 123) is generated in the processing chip (114, 124) illustrated in the sub-drawings (b) of FIG. 1.

For example, the technical feature of a receiving STA receiving a control signal can be understood as a technical feature of a control signal being received by a transceiver (113, 123) illustrated in sub-drawing (a) of FIG. 1. Alternatively, the technical feature of a receiving STA receiving a control signal can be understood as a technical feature of a control signal received by a transceiver (113, 123) illustrated in sub-drawing (a) of FIG. 1 being acquired by a processor (111, 121) illustrated in sub-drawing (a) of FIG. 1. Alternatively, the technical feature of a receiving STA receiving a control signal can be understood as a technical feature of a control signal received by a transceiver (113, 123) illustrated in sub-drawing (b) of FIG. 1 being acquired by a processing chip (114, 124) illustrated in sub-drawing (b) of FIG. 1.

Referring to sub-drawing (b) of FIG. 1, software code (115, 125) may be included in the memory (112, 122). The software code (115, 125) may include instructions that control the operation of the processor (111, 121). The software code (115, 125) may be included in various programming languages.

The processor (111, 121) or processing chip (114, 124) illustrated in FIG. 1 may include an application-specific integrated circuit (ASIC), another chipset, logic circuit, and/or data processing device. The processor may be an application processor (AP). For example, the processor (111, 121) or processing chip (114, 124) illustrated in FIG. 1 may include at least one of a digital signal processor (DSP), a central processing unit (CPU), a graphics processing unit (GPU), and a modem (modulator and demodulator). For example, the processors (111, 121) or processing chips (114, 124) illustrated in FIG. 1 may be a SNAPDRAGON® series processor manufactured by Qualcomm®, an EXYNOS® series processor manufactured by Samsung®, an A series processor manufactured by Apple®, a HELIO® series processor manufactured by MediaTek®, an ATOM® series processor manufactured by INTEL®, or an enhanced processor thereof.

In the present specification, “uplink” may refer to a link for communication from a non-AP STA to an AP STA, and uplink PPDUs/packets/signals, etc. may be transmitted via the uplink. Furthermore, in the present specification, “downlink” may refer to a link for communication from an AP STA to a non-AP STA, and downlink PPDUs/packets/signals, etc. may be transmitted via the downlink.

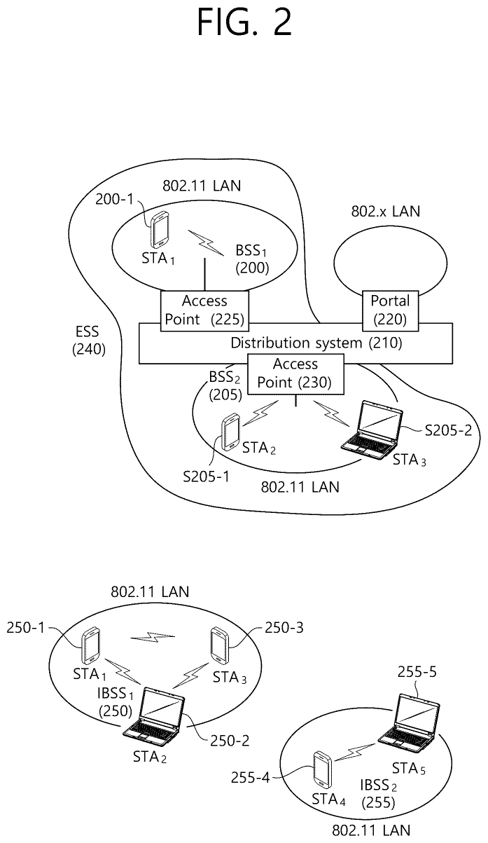

FIG. 2 is a conceptual diagram illustrating the structure of a wireless local area network (WLAN).

The top of FIG. 2 illustrates the structure of an infrastructure BSS (basic service set) of the Institute of Electrical and Electronic Engineers (IEEE) 802.11 standard.

Referring to the top of FIG. 2, the wireless LAN system may include one or more infrastructure BSSs (200, 205) (hereinafter referred to as BSS). A BSS (200, 205) is a set of APs (access points, 225) and STAs (stations, 200-1) that have successfully synchronized and can communicate with each other; it does not refer to a specific area. A BSS (205) may include one or more connectable STAs (205-1, 205-2) connected to a single AP (230).

A BSS may include at least one STA, an AP (225, 230) that provides a distribution service, and a distribution system (DS, 210) that connects multiple APs.

A distributed system (210) can connect multiple BSSs (200, 205) to implement an extended service set (ESS) 240. An ESS (240) can be used as a term to indicate a network formed by connecting one or more APs through the distributed system (210). APs included in a single ESS (240) can have the same SSID (service set identifier).

A portal (220) can serve as a bridge, connecting a wireless LAN network (IEEE 802.11) to another network (e.g., 802.X).

In a BSS, such as the upper portion of FIG. 2, a network between APs (225, 230) and a network between APs (225, 230) and STAs (200-1, 205-1, 205-2) can be implemented. However, it may also be possible to establish a network and perform communication between STAs without an AP (225, 230). A network that establishes a network and performs communication between STAs without an AP (225, 230) is defined as an ad-hoc network or an independent basic service set (IBSS).

The bottom of FIG. 2 is a conceptual diagram illustrating an IBSS.

Referring to the bottom of FIG. 2, an IBSS is a BSS that operates in ad-hoc mode. Since an IBSS does not include an AP, there is no centralized management entity. That is, in the IBSS, STAs (250-1, 250-2, 250-3, 255-4, 255-5) are managed in a distributed manner. In IBSS, all STAs (250-1, 250-2, 250-3, 255-4, 255-5) can be mobile STAs, and access to distributed systems is not permitted, forming a self-contained network.

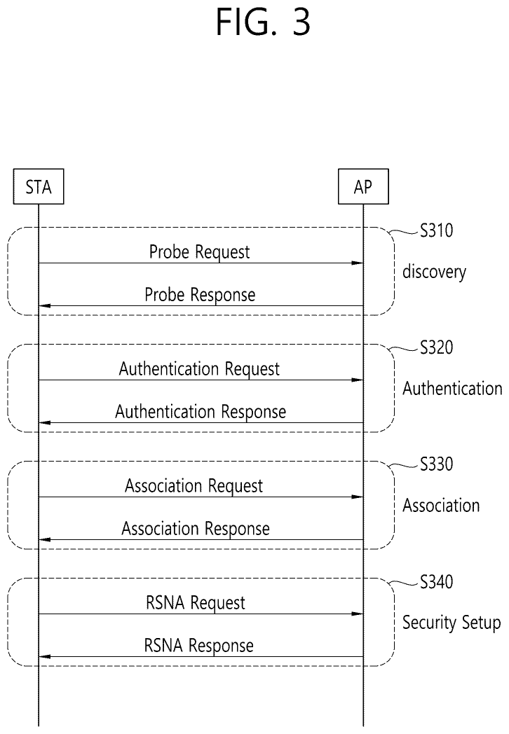

FIG. 3 is a diagram illustrating a typical link setup process.

In the illustrated step S310, a STA may perform a network discovery operation. This network discovery operation may include scanning. That is, for a STA to access a network, it must find a network it can join. Before joining a wireless network, a STA must identify compatible networks. The process of identifying networks in a specific area is called scanning. Scanning methods include active scanning and passive scanning.

FIG. 3 illustrates a network discovery operation that includes an active scanning process as an example. In active scanning, a STA performing scanning transmits a probe request frame to discover nearby APs while moving through channels and awaits a response. The responder transmits a probe response frame to the STA that transmitted the probe request frame in response to the probe request frame. Here, the responder may be the STA that last transmitted a beacon frame in the BSS of the channel being scanned. In a BSS, the AP transmits the beacon frame, making it the responder. In an IBSS, STAs within the IBSS take turns transmitting beacon frames, so the responder is not fixed. For example, a STA that transmits a probe request frame on channel 1 and receives a probe response frame on channel 1 may store the BSS-related information contained in the received probe response frame and move to the next channel (e.g., channel 2) to perform scanning in the same manner (e.g., transmitting and receiving probe requests and responses on channel 2).

Although not shown in the example of FIG. 3, the scanning operation can also be performed passively. A STA performing scanning based on passive scanning may wait for a beacon frame while moving between channels. A beacon frame, a management frame in IEEE 802.11, announces the presence of a wireless network and is periodically transmitted to scanning STAs to discover and join the network. In the BSS, the AP periodically transmits beacon frames, while in the IBSS, STAs within the IBSS take turns transmitting beacon frames. When a scanning STA receives a beacon frame, it stores the BSS information contained in the beacon frame and moves to a different channel, recording the beacon frame information on each channel. Upon receiving a beacon frame, the STA stores the BSS-related information contained in the received beacon frame and moves to the next channel, performing scanning on the next channel using the same method.

A STA that discovers a network can perform an authentication process in step S320. This authentication process can be referred to as the first authentication process to clearly distinguish it from the security setup operation of step S340, described below. The authentication process of S320 may include a process in which the STA transmits an authentication request frame to the AP, and the AP transmits an authentication response frame to the STA in response. The authentication frame used for the authentication request/response corresponds to a management frame.

The authentication frame may include information such as an authentication algorithm number, an authentication transaction sequence number, a status code, a challenge text, a Robust Security Network (RSN), and a Finite Cyclic Group (FCG).

The STA may transmit the authentication request frame to the AP. The AP may determine whether to grant authentication to the STA based on the information contained in the received authentication request frame. The AP may provide the STA with the result of the authentication process via an authentication response frame.

A successfully authenticated STA may perform the connection process based on step S330. The association process involves the STA sending an association request frame to the AP, and the AP responding by sending an association response frame to the STA. For example, the association request frame may include information related to various capabilities, such as a beacon listen interval, a service set identifier (SSID), supported rates, supported channels, RSN, mobility domain, supported operating classes, a Traffic Indication Map Broadcast request, and interworking service capabilities. For example, the association response frame may include information related to various capabilities, status codes, Association ID (AID), supported rates, Enhanced Distributed Channel Access (EDCA) parameter sets, Received Channel Power Indicator (RCPI), Received Signal to Noise Indicator (RSNI), mobility domains, timeout intervals (association comeback times), overlapping BSS scan parameters, TIM broadcast responses, QoS maps, etc.

Subsequently, in step S340, the STA may perform a security setup process. The security setup process in step S340 may include, for example, a process of setting up a private key through four-way handshaking using an Extensible Authentication Protocol over LAN (EAPOL) frame.

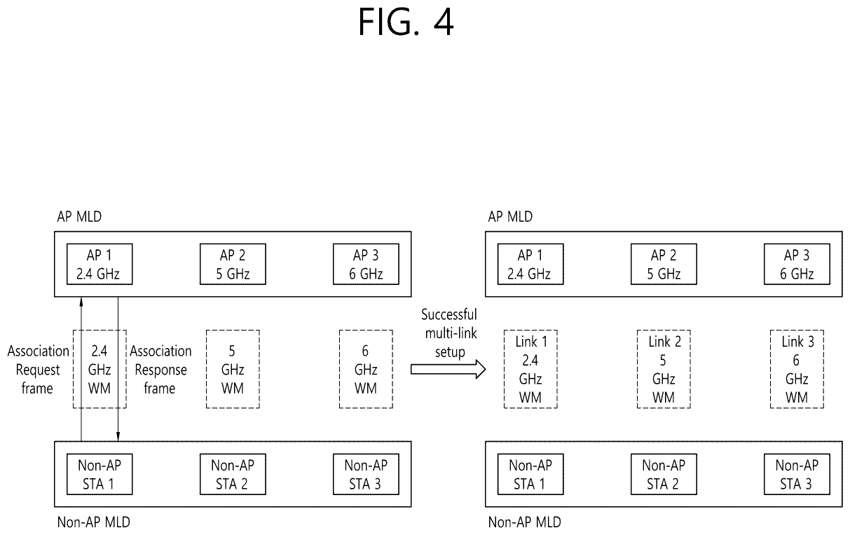

FIG. 4 illustrates an embodiment of a multi-link (ML).

As illustrated in FIG. 4, multiple multi-link devices (MLDs) can communicate via a multi-link. The MLDs can be categorized into AP MLDs, which include multiple AP STAs, and non-AP MLDs, which include multiple non-AP STAs. Specifically, the AP MLD may include affiliated APs (e.g., AP STAs), and the non-AP MLD may include affiliated STAs (e.g., non-AP STAs, or user-STAs).

The multi-link may include a first link and a second link, and different channels/subchannels/frequency resources may be allocated to the first and second links. The first and second multi-links may be identified using a 4-bit (or other n-bit) link ID. The first and second links may be configured in the same 2.4 GHz, 5 GHz, or 6 GHz band. Alternatively, the first and second links may be configured in different bands.

The AP MLD of FIG. 4 includes three affiliated APs. In the example of FIG. 4, AP1 may operate in the 2.4 GHz band, AP2 may operate in the 5 GHz band, and AP3 may operate in the 6 GHz band. In the example of FIG. 4, the first link, in which AP1 and non-AP1 operate, may be defined as a channel/subchannel/frequency resource within the 2.4 GHz band. Furthermore, in the example of FIG. 4, the second link, in which AP2 and non-AP2 operate, may be defined as a channel/subchannel/frequency resource within the 5 GHz band. Additionally, in the example of FIG. 4, the third link where AP3 and non-AP3 operate can be defined as a channel/subchannel/frequency resource within the 6 GHz band.

In the example of FIG. 4, AP1 can initiate a multilink setup procedure (ML setup procedure) by transmitting an Association Request frame to non-AP STAL. In the example of FIG. 4, non-AP STA1 can transmit an Association Response frame in response to the Association Request frame. Each AP (e.g., AP1/2/3) depicted in FIG. 4 may be identical to the APs depicted in FIG. 1 and/or FIG. 2, and each non-AP (e.g., non-AP1/2/3) depicted in FIG. 4 may be identical to the STAs (e.g., user STAs or non-AP STAs) depicted in FIG. 1 and/or FIG. 2.

The specific features of the present specification are not limited to the specific features depicted in FIG. 4. That is, the number of links can be defined in various ways, and multiple links can be defined in various ways within at least one band.

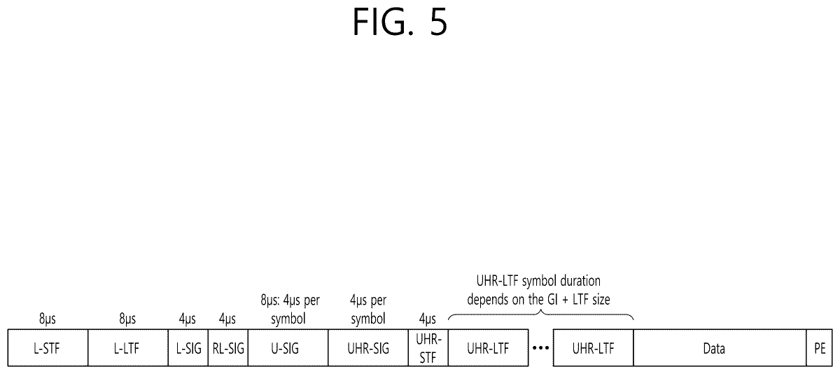

FIG. 5 illustrates a PPDU (physical protocol data unit or physical layer (PHY) protocol data unit) transmitted/received by a STA of the present specification.

A STA (e.g., an AP STA, a non-AP STA, an AP MLD, or a non-AP MLD) of the present specification can transmit and/or receive the PPDU of FIG. 5. The PPDU described herein may have, for example, the structure of FIG. 5. Furthermore, the PPDU described herein, an Ultra High Reliability (UHR) PPDU, may be referred to by various names, such as a transmission PPDU, a reception PPDU, a first type PPDU, or an Nth type PPDU. The PPDU described herein may be used in a WLAN system defined according to IEEE 802.11bn and/or a next-generation WLAN system that enhances IEEE 802.11bn.

The PPDU of FIG. 5 may relate to various PPDU types used in a UHR system. For example, the example of FIG. 5 can be used for at least one of single-user (SU) mode/type/transmission, multi-user (MU) mode/type/transmission, and null data packet (NDP) mode/type/transmission related to channel sounding. For example, if the example of FIG. 5 relates to NDP, the illustrated Data field may be omitted. If the PPDU of FIG. 5 is used for Trigger-based (TB) mode, the UHR-SIG of FIG. 5 may be omitted. In other words, a STA that has received a Trigger frame for UL-MU (Uplink-MU) communication may transmit a PPDU with the UHR-SIG omitted in the example of FIG. 5.

In FIG. 5, L-STF or UHR-LTF may be referred to as a preamble or physical preamble, and may be generated/transmitted/received/acquired/decoded in the physical layer (included in the transmitting/receiving STA).

Each block illustrated in FIG. 5 may be referred to as a field/subfield/signal, etc. The names of these fields/subfields/signals may be, as illustrated in FIG. 5, a legacy short training field (L-STF), a legacy long training field (L-LTF), a legacy signal (L-SIG), a repeated L-SIG (RL-SIG), Universal Signal (U-SIG), UHR-signal (UHR-SIG), etc.

The subcarrier spacing of the L-STF, L-LTF, L-SIG, RL-SIG, U-SIG, and UHR-SIG fields in FIG. 5 may be set to 312.5 kHz, and the subcarrier spacing of the UHR-STF, UHR-LTF, and Data fields may be set to 78.125 kHz. That is, the tone indices (or subcarrier indices) of the L-STF, L-LTF, L-SIG, RL-SIG, U-SIG, and UHR-SIG fields may be expressed in units of 312.5 kHz, and the tone indices (or subcarrier indices) of the UHR-STF, UHR-LTF, and Data fields may be expressed in units of 78.125 kHz.

In the PPDU in FIG. 5, L-LTF and L-STF may be identical to conventional fields (e.g., non-HT LTF and non-HT STF defined in conventional WLAN standards).

The L-SIG field of FIG. 5 may include, for example, 24 bits of bit information. For example, the 24 bits of information may include a 4 bit Rate field, a 1 bit Reserved bit, a 12 bit Length field, a 1 bit Parity bit, and a 6 bit Tail bit. For example, the 12 bit Length field may include information about the length or time duration of the PPDU. For example, the value of the 12 bit Length field may be determined based on the type of the PPDU. For example, if the PPDU is a non-HT (non-High Throughput), HT (High Throughput), VHT (Very High Throughput) PPDU, or an EHT (extremely high throughput) PPDU or UHR PPDU, the value of the Length field may be determined as a multiple of 3. For example, if the PPDU is a HE PPDU, the value of the Length field may be determined as “a multiple of 3+1” or “a multiple of 3+2”. In other words, for non-HT, HT, VHT PPDUs, EHT PPDUs, and UHR PPDUs, the Length field value can be determined as a multiple of 3. For HE (High Efficiency) PPDUs, the Length field value can be determined as “a multiple of 3+1” or “a multiple of 3+2.” In other words, the Length field in a UHR PPDU is set to a value satisfying the condition that the remainder is zero when LENGTH is divided by 3.

For example, a (non-AP and AP) STA can apply BCC encoding based on a code rate of ½ to the 24-bit information in the L-SIG field. The transmitting STA can then acquire 48 BCC encoding bits. BPSK modulation can be applied to the 48 encoding bits, generating 48 BPSK symbols. The transmitting STA can map 48 BPSK symbols to positions other than the pilot subcarriers {subcarrier indices −21, −7, +7, +21} and the DC subcarrier {subcarrier index 0}. Consequently, the 48 BPSK symbols can be mapped to subcarrier indices −26 to −22, −20 to −8, −6 to −1, +1 to +6, +8 to +20, and +22 to +26. The transmitting STA can additionally map signals {-1, −1, −1, 1} to subcarrier indices {-28, −27, +27, +28}. These signals can be used for channel estimation for the frequency domain corresponding to {-28, −27, +27, +28}.

For example, (non-AP and AP) STAs can generate RL-SIGs that are generated identically to L-SIGs. BPSK modulation can be applied to RL-SIG. The receiving (non-AP and AP) STA can determine whether the received PPDU is a HE PPDU, EHT PPDU, or UHR PPDU based on the presence of RL-SIG. In other words, the receiving (non-AP and AP) STA can determine whether the received PPDU is a HE PPDU, EHT PPDU, or UHR PPDU if RL-SIG is present. In other words, the receiving (non-AP and AP) STA can determine whether the received PPDU is a non-HT PPDU, HT PPDU, or VHT PPDU if RL-SIG is not present. In other words, the RL-SIG field is a repeat of the L-SIG field and is used to differentiate a UHR PPDU from a non-HT PPDU, HT PPDU, and VHT PPDU.

A Universal Signal-Integrated (U-SIG) may be inserted after the RL-SIG in FIG. 5. The U-SIG may be referred to by various names, such as the first SIG field, the first SIG, the first type SIG, the control signal, the control signal field, the first (type) control signal, the common control field, and the common control signal.

The U-SIG may contain N bits of information and may include information for identifying the type of the EHT PPDU. For example, the U-SIG may be composed based on two symbols (e.g., two consecutive/contiguous OFDM symbols). Each symbol for the U-SIG (e.g., the OFDM symbol) may have a duration of 4 s. Each symbol of the U-SIG may be used to transmit 26 bits of information. For example, each symbol of the U-SIG may be transmitted and received based on 52 data tones and 4 pilot tones.

For example, A bit information (e.g., 52 uncoded bits) can be transmitted through U-SIG, and the first symbol of U-SIG can transmit the first X bits of information (e.g., 26 uncoded bits) out of the total A bit information, and the second symbol of U-SIG can transmit the remaining Y bits of information (e.g., 26 uncoded bits) out of the total A bit information. For example, the transmitting STA can obtain 26 uncoded bits included in each U-SIG symbol. The transmitting STA can perform convolutional encoding (e.g., BCC encoding) based on a rate of R=½ to generate 52 coded bits, and perform interleaving on the 52 coded bits. The transmitting STA can perform BPSK modulation on the interleaved 52 BPSK symbols to generate 52 BPSK symbols allocated to each U-SIG symbol. A single U-SIG symbol can be transmitted based on 56 tones (subcarriers) ranging from subcarrier index −28 to subcarrier index+28, excluding DC index 0. The 52 BPSK symbols generated by the transmitting STA can be transmitted based on the remaining tones (subcarriers) excluding the pilot tones −21, −7, +7, and +21.

For example, the A-bit information (e.g., 52 uncoded bits) transmitted by the U-SIG can include a CRC field (e.g., a 4-bit field) and a tail field (e.g., a 6-bit field). The CRC field and tail field can be transmitted via the second symbol of the U-SIG. The CRC field can be generated based on the 26 bits allocated to the first symbol of the U-SIG and the remaining 16 bits within the second symbol, excluding the CRC/tail field, and can be generated based on a conventional CRC calculation algorithm. Additionally, the tail field can be used to terminate the trellis of the convolutional decoder and can be set to “000000,” for example.

The A-bit information (e.g., 52 uncoded bits) transmitted by the U-SIG (or U-SIG field) can be divided into version-independent bits and version-dependent bits. For example, the size of the version-independent bits can be fixed or variable. For example, the version-independent bits can be assigned only to the first symbol of the U-SIG, or the version-independent bits can be assigned to both the first and second symbols of the U-SIG. For example, the version-independent bits and version-dependent bits can be referred to by various names, such as the first control bit and the second control bit.

For example, the version-independent bits of the U-SIG can include a 3-bit PHY version identifier. For example, a 3-bit PHY version identifier may include information related to the PHY version of a transmitted/received PPDU. For example, a first value (e.g., a value of 000) of the 3-bit PHY version identifier may indicate that the transmitted/received PPDU is an EHT PPDU. Additionally, a second value (e.g., a value of 001) of the 3-bit PHY version identifier may indicate that the transmitted/received PPDU is a UHR PPDU.

In other words, when an (AP/non-AP) STA transmits an EHT PPDU, it may set the 3-bit PHY version identifier to the first value. In other words, a receiving (AP/non-AP) STA may determine that the received PPDU is an EHT PPDU based on a PHY version identifier having the first value, and may determine that the received PPDU is a UHR PPDU based on a PHY version identifier having the second value.

For example, the version-independent bits of U-SIG may include a 1-bit UL/DL flag field. The first value of the 1-bit UL/DL flag field relates to UL communication, and the second value of the UL/DL flag field relates to DL communication.

For example, the version-independent bits of the U-SIG may include information about the length of the TXOP and information about the BSS color ID.

For example, if the UHR PPDU is classified into various types (e.g., a type related to SU transmission (performed based on UL or DL), a type related to DL transmission, a type related to NDP transmission, a type related to DL non-MU-MIMO, a type related to DL MU-MIMO, a type related to Multi-AP operation, a type related to CBF (Coordinated beamforming), SR (Spatial Reuse), a type related to C-OFDMA (Coordinated OFDMA), a type related to C-TDMA (Coordinated TDMA)), information about the type of the EHT PPDU (e.g., 2-bit or 3-bit information) may be included in the version-dependent bits of the U-SIG.

For example, U-SIG may include 1) a bandwidth field including information about bandwidth, 2) a field including information about the Modulation and Coding Scheme (MCS) technique applied to UHR-SIG, 3) an indication field including information about whether dual subcarrier modulation (DCM) technique is applied to UHR-SIG, 4) a field including information about the number of symbols used for UHR-SIG, 5) a field including information about whether UHR-SIG is generated across the entire band, 6) a field including information about the type of UHR-LTF/STF, and 7) a field indicating the length of UHR-LTF and the CP length.

Preamble puncturing may be applied to the PPDU of FIG. 5. Preamble puncturing means applying puncturing to a portion of the entire band of the PPDU (e.g., the secondary 20 MHz band). For example, when an 80 MHz PPDU is transmitted, the STA can apply puncturing to the secondary 20 MHz band within the 80 MHz band and transmit the PPDU only through the primary 20 MHz band and the secondary 40 MHz band.

For example, the preamble puncturing pattern can be preset. For example, if the first puncturing pattern is applied, puncturing can be applied only to the secondary 20 MHz band within the 80 MHz band. For example, if the second puncturing pattern is applied, puncturing can be applied only to one of the two secondary 20 MHz bands included in the secondary 40 MHz band within the 80 MHz band. For example, if the third puncturing pattern is applied, puncturing can be applied only to the secondary 20 MHz band included in the primary 80 MHz band within the 160 MHz band (or 80+80 MHz band). For example, when the fourth puncturing pattern is applied, puncturing may be applied to at least one 20 MHz channel not included in the primary 40 MHz band, while the primary 40 MHz band is present within the 160 MHz band (or the 80+80 MHz band).

Information regarding preamble puncturing applied to a PPDU may be included in the U-SIG and/or UHR-SIG. For example, the first field of the U-SIG may include information regarding the contiguous bandwidth of the PPDU, and the second field of the U-SIG may include information regarding preamble puncturing applied to the PPDU.

For example, the U-SIG and UHR-SIG may include information regarding preamble puncturing based on the following method. If the bandwidth of the PPDU exceeds 80 MHz, the U-SIG may be configured individually in 80 MHz units. For example, if the bandwidth of a PPDU is 160 MHz, the PPDU may include a first U-SIG for a first 80 MHz band and a second U-SIG for a second 80 MHz band. In this case, a first field of the first U-SIG may include information about the 160 MHz bandwidth, and a second field of the first U-SIG may include information about preamble puncturing applied to the first 80 MHz band (e.g., information about a preamble puncturing pattern). In addition, a first field of the second U-SIG may include information about the 160 MHz bandwidth, and a second field of the second U-SIG may include information about preamble puncturing applied to the second 80 MHz band (e.g., information about a preamble puncturing pattern). Meanwhile, the UHR-SIG contiguous to the first U-SIG may include information about preamble puncturing applied to the second 80 MHz band (e.g., information about a preamble puncturing pattern), and the UHR-SIG contiguous to the second U-SIG may include information about preamble puncturing applied to the first 80 MHz band (e.g., information about a preamble puncturing pattern).

Additionally or alternatively, the U-SIG and UHR-SIG may include information regarding preamble puncturing based on the following methods. The U-SIG may include information regarding preamble puncturing for all bands (e.g., information regarding the preamble puncturing pattern). That is, the UHR-SIG does not include information regarding preamble puncturing, and only the U-SIG may include information regarding preamble puncturing (e.g., information regarding the preamble puncturing pattern).

The U-SIG may be configured in 20 MHz units. For example, if an 80 MHz PPDU is configured, the U-SIG may be duplicated. That is, four identical U-SIGs may be included within the 80 MHz PPDU. PPDUs exceeding the 80 MHz bandwidth may include different U-SIGs.

The UHR-SIG of FIG. 5 may include control information for a receiving STA. The UHR-SIG may be transmitted over at least one symbol, each symbol having a length of 4 s. Information regarding the number of symbols used for the UHR-SIG may be included in the U-SIG.

The UHR-SIG provides additional signals to the U-SIG field to enable the STA to interpret/decode the UHR PPDU. The UHR-SIG field may include U-SIG overflow bits common to all users. The UHR-SIG field also includes resource allocation information, allowing the STA to look up resources used in fields including the data field, UHR-STF, and UHR-LTF (e.g., UHR modulated fields of a UHR PPDU).

The frequency resources of the UHR-LTF, UHR-STF, and data fields illustrated in FIG. 5 can be determined based on resource units (RUs) defined by multiple subcarriers/tones. That is, the UHR-LTF, UHR-STF, and data fields of the present specification can be transmitted/received via resource units (RUs) defined by multiple subcarriers/tones.

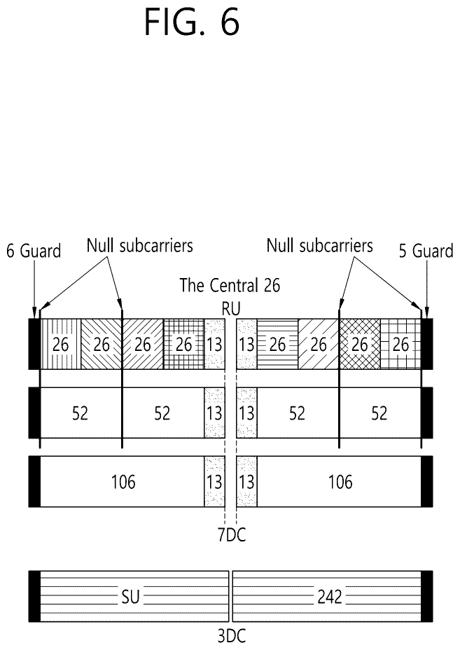

FIG. 6 is a diagram illustrating the layout of resource units (RUs) used for a 20 MHz PPDU. That is, the UHR-LTF, UHR-STF, and/or data fields included in a 20 MHz PPDU can be transmitted/received via at least one of the various RUs defined in FIG. 6.

As illustrated at the top of FIG. 6, 26 units (e.g., units corresponding to 26 tones) can be arranged. In the leftmost band of the 20 MHz band, six tones can be used as a guard band, and in the rightmost band of the 20 MHz band, five tones can be used as a guard band. Furthermore, seven DC tones can be inserted into the center band (i.e., the DC band), and 26 units, corresponding to 13 tones each, can exist on the left and right sides of the DC band. Furthermore, 26, 52, and 106 units can be allocated to other bands. Each unit can be assigned to a receiving station, i.e., a user.

Meanwhile, the RU arrangement of FIG. 6 can be utilized not only for multiple users (MUs) but also for single users (SUs). In this case, as shown at the bottom of FIG. 6, a single 242-unit can be used, in which case three DC tones can be inserted.

In the example of FIG. 6, RUs of various sizes, such as 26-RU, 52-RU, 106-RU, and 242-RU, are proposed. Since the specific sizes of these RUs can be expanded or increased, the present embodiment is not limited to the specific sizes of each RU (e.g., the number of corresponding tones). In the present specification, N-RU may be represented as N-tone RU, etc. For example, 26-RU may be represented as 26-tone RU.

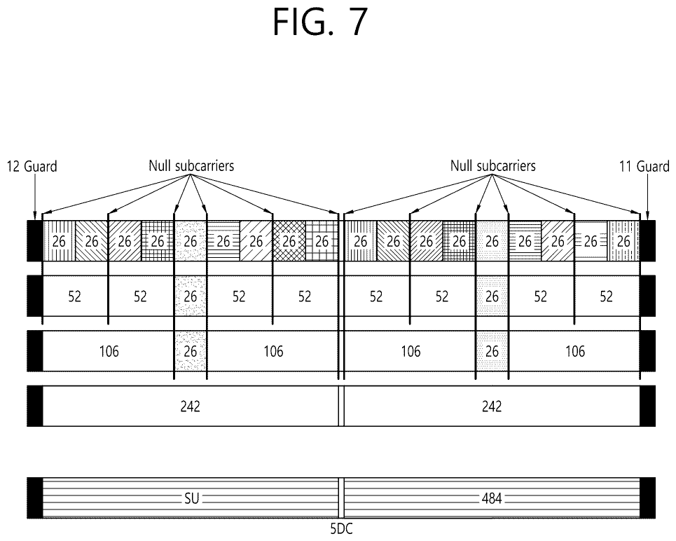

FIG. 7 is a diagram illustrating the layout of resource units (RUs) used for a 40 MHz PPDU.

Similar to the example in FIG. 6, which used RUs of various sizes, the example in FIG. 7 can also use RUs of 26, 52, 106, 242, and 484 RUs. Furthermore, five DC tones can be inserted at the center frequency, 12 tones can be used as guard bands in the leftmost band of the 40 MHz band, and 11 tones can be used as guard bands in the rightmost band of the 40 MHz band.

Also, as illustrated, a 484-RU can be used for a single user. Similarly to the example in FIG. 6, the specific number of RUs can be varied.

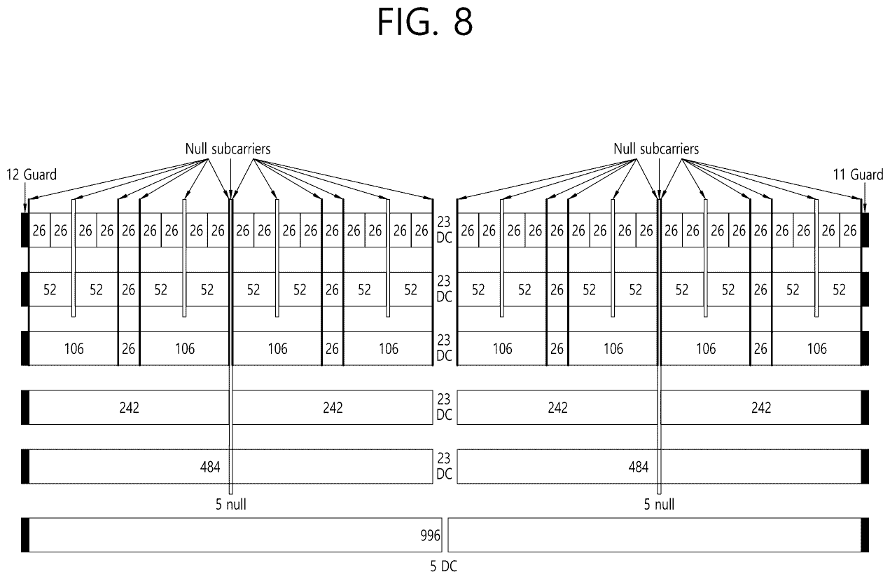

FIG. 8 is a diagram illustrating the layout of resource units (RUs) used for an 80 MHz PPDU. The arrangement of resource units (RUs) used in the present specification may vary. For example, the arrangement of resource units (RUs) used in the 80 MHz band may vary.

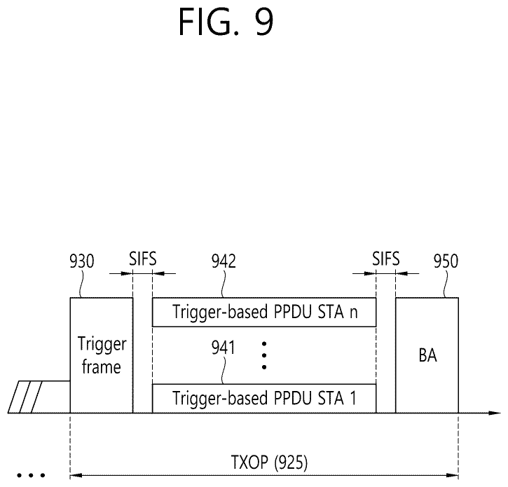

FIG. 9 illustrates the operation according to UL-MU. As illustrated, a transmitting STA (e.g., an AP) may acquire a TXOP (925) by performing channel access through contending (e.g., backoff operation) and transmit a Trigger frame (930). That is, the transmitting STA (e.g., an AP) may transmit a PPDU including the Trigger frame (930). Upon receiving the PPDU including the Trigger frame, a TB (trigger-based) PPDU is transmitted after a delay equal to SIFS.

TB PPDUs (941, 942) are transmitted at the same time and may be transmitted from multiple STAs (e.g., user STAs) whose AIDs are indicated in the Trigger frame (930). The ACK frame (950) for the TB PPDU can be implemented in various forms. For example, the ACK frame (950) for the TB PPDU can be implemented in the form of a BA (block ACK).

In FIG. 9, transmission(s) of the Trigger Frame (930), TB PPDUs (941, 942), and/or the ACK frame (950) can be performed within the TXOP (925).

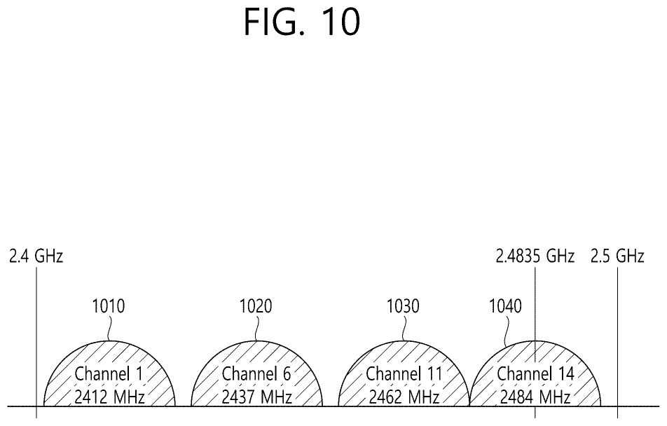

FIG. 10 illustrates an example of channels used/supported/defined within the 2.4 GHz band.

The 2.4 GHz band may also be referred to by other names, such as the first band (band). Furthermore, the 2.4 GHz band may refer to a frequency range in which channels with a center frequency adjacent to 2.4 GHz (e.g., channels with a center frequency between 2.4 and 2.5 GHz) are used/supported/defined.

The 2.4 GHz band may include multiple 20 MHz channels. Each 20 MHz channel within the 2.4 GHz band may have multiple channel indices (e.g., indices 1 through 14). For example, the center frequency of a 20 MHz channel assigned channel index 1 may be 2.412 GHz, the center frequency of a 20 MHz channel assigned channel index 2 may be 2.417 GHz, and the center frequency of a 20 MHz channel assigned channel index N may be (2.407+0.005*N) GHz. Channel indices may be referred to by various names, such as channel numbers. The specific numerical values of the channel indices and center frequencies may vary.

FIG. 10 illustrates four channels within the 2.4 GHz band. The illustrated first frequency range (1010) through fourth frequency range (1040) may each include one channel. For example, the first frequency domain (1010) may include channel 1 (a 20 MHz channel having an index of 1). At this time, the center frequency of channel 1 may be set to 2412 MHz. The second frequency domain (1020) may include channel 6. At this time, the center frequency of channel 6 may be set to 2437 MHz. The third frequency domain (1030) may include channel 11. At this time, the center frequency of channel 11 may be set to 2462 MHz. The fourth frequency domain (1040) may include channel 14. At this time, the center frequency of channel 14 may be set to 2484 MHz.

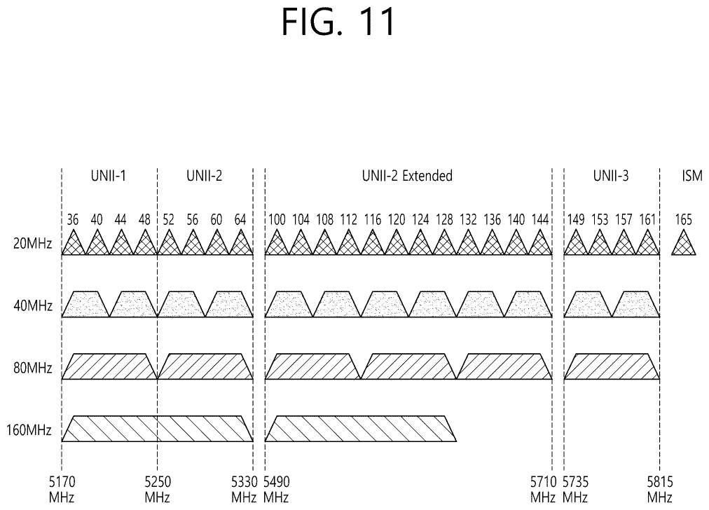

FIG. 11 illustrates an example of channels used/supported/defined within the 5 GHz band.

The 5 GHz band may also be referred to as a second band, etc. The 5 GHz band may refer to a frequency range in which channels with a center frequency greater than or equal to 5 GHz and less than 6 GHz (or less than 5.9 GHz) are used/supported/defined. Alternatively, the 5 GHz band may include multiple channels between 4.5 GHz and 5.5 GHz. The specific figures shown in FIG. 11 are subject to change.

The multiple channels within the 5 GHz band include Unlicensed National Information Infrastructure (UNII)-1, UNII-2, UNII-3, and ISM. UNII-1 may be referred to as UNII Low. UNII-2 may include frequency ranges called UNII Mid and UNII-2 Extended. UNII-3 may be referred to as UNII-Upper.

Multiple channels can be configured within the 5 GHz band, and the bandwidth of each channel can be variously configured, such as 20 MHz, 40 MHz, 80 MHz, or 160 MHz. For example, the 5170 MHz to 5330 MHz frequency range within UNII-1 and UNII-2 can be divided into eight 20 MHz channels. The 5170 MHz to 5330 MHz frequency range can be divided into four channels via a 40 MHz frequency band. The 5170 MHz to 5330 MHz frequency range can be divided into two channels via an 80 MHz frequency band. Alternatively, the 5170 MHz to 5330 MHz frequency range can be divided into one channel via a 160 MHz frequency band.

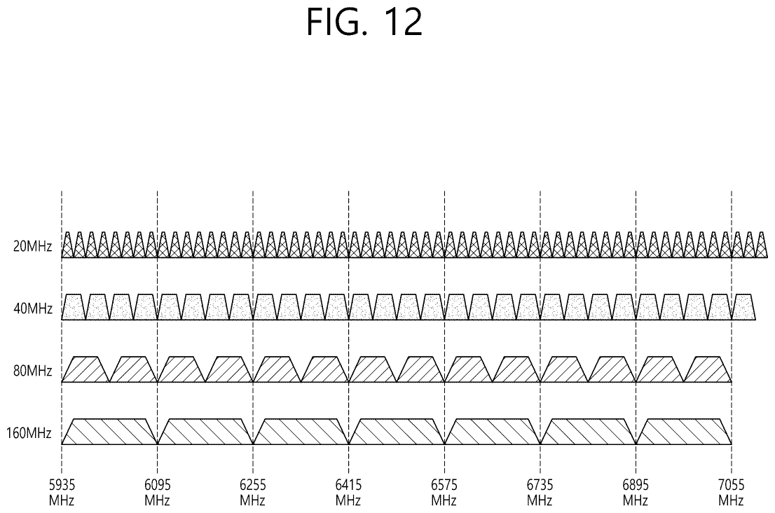

FIG. 12 illustrates an example of channels used/supported/defined within the 6 GHz band.

The 6 GHz band may be referred to by other names, such as the third band/band. The 6 GHz band may refer to a frequency range where channels with a center frequency of 5.9 GHz or higher are used, supported, or defined. The specific values shown in FIG. 12 may vary.

For example, the 20 MHz channel in FIG. 12 may be defined starting from 5.940 GHz. Specifically, the leftmost channel among the 20 MHz channels in FIG. 12 may have an index of 1 (or channel index, channel number, etc.) and may be assigned a center frequency of 5.945 GHz. In other words, the center frequency of channel index N may be determined as (5.940+0.005*N) GHz.

Accordingly, the indices (or channel numbers) of the 20 MHz channels in FIG. 12 are 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, 197, 201, 205, 209, 213, 217, 221, 225, 229, 233. Additionally, according to the aforementioned (5.940+0.005*N) GHz rule, the indices of the 40 MHz channels in FIG. 12 can be 3, 11, 19, 27, 35, 43, 51, 59, 67, 75, 83, 91, 99, 107, 115, 123, 131, 139, 147, 155, 163, 171, 179, 187, 195, 203, 211, 219, and 227.

Hereinafter, the structure, type and/or sub-type of the MAC frame are described.

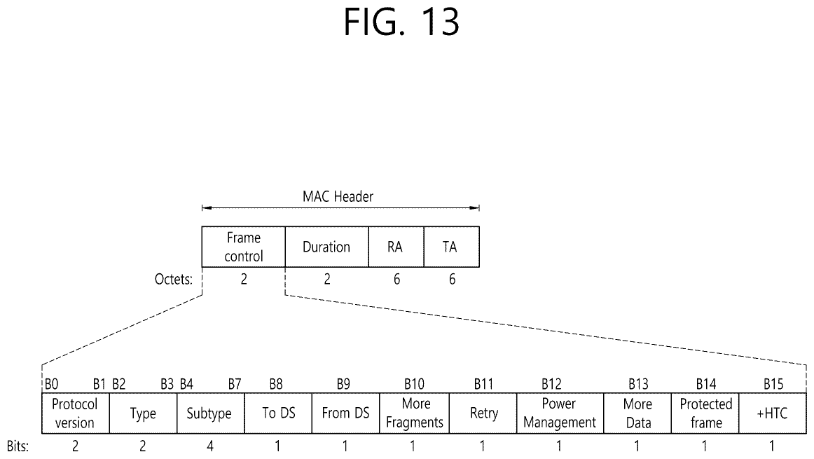

FIG. 13 illustrates an example of a MAC frame header. As illustrated, the MAC frame may include a 2-octet frame control field/information, a 2-octet duration field/information, a 6-octet RA (Receiver Address) field/information, and a 6-octet TA (Transmitter Address) field/information. As illustrated in FIG. 13, the four fields may be contiguous. The MAC header of FIG. 13 may be modified in various ways, with new fields inserted between the four fields illustrated, or at least one of the fields illustrated may be omitted.

The MAC header illustrated in FIG. 13 may be positioned at the very beginning of the MAC frame. That is, the MAC frame may include a MAC header as illustrated in FIG. 13 and a MAC body field/information contiguous to the MAC header. The MAC frame including the MAC header of FIG. 13 is inserted/included in the data field of the PPDU (e.g., UHR PPDU) illustrated in FIG. 5.

The MAC frames included in the data field of the PPDU of the present specification can be classified into various types. For example, the MAC frames of the present specification can be classified into control frames, management frames, and data frames.

For example, the management frame includes the Association Request, Association Response, Reassociation Request, Reassociation Response, Probe Request, Probe Response, Beacon, Disassociation, Authentication, and Deauthentication frames/signals defined in conventional WLANs. For the management frame, the type fields (B3 and B2) in FIG. 13 are set to 00. Additionally, the values of the subtype fields (B7, B6, B5, B4) in FIG. 13 are as follows: Association Request (0000), Association Response (0001), Reassociation Request (0010), Reassociation Response (0011), Probe Request (0100), Probe Response (0101), Beacon (1000), Disassociation (1010), Authentication (1011), Deauthentication (1100).

For example, the control frame includes the Trigger Beamforming Report Poll, NDP Announcement (NDPA), Control Frame Extension, Control Wrapper, Block Ack Request (BlockAckReq), Block Ack (BlockAck), PS-Poll, RTS, CTS, Ack, and CF-End frames/signals defined in conventional WLANs. For the control frame, the values of the type fields (B3 and B2) in FIG. 13 are set to 01. Additionally, the values of the subtype fields (B7, B6, B5, B4) in FIG. 13 are as follows: Trigger (0010), Beamforming Report Poll (0100), NDP Announcement (0101), Control Frame Extension (0110), Control Wrapper (0111), BlockAckReq (1000), BlockAck (1001), PS-Poll (1010), RTS (1011), CTS (1100), Ack (1101), CF-End (1110).

For example, the data frame includes (QoS) Data, (QoS) Null, etc., as defined in conventional WLANs. For the data frame, the values of the type fields (B3 and B2) in FIG. 13 are set to 10.

The MAC frames/signals used in the present specification can be identified through the type field/information and subtype field/information described above. For example, a “trigger frame” in the present specification may refer to a MAC frame in which the type bits B3 and B2 in the frame control field of the MAC header are set to 01, while the subtype bits B7, B6, B5, and B4 in the frame control field are set to 0010. The various MAC frames described in the present specification are inserted/included in the data fields of various PPDUs (e.g., HE/VHT/HE/EHT/UHR PPDUs).

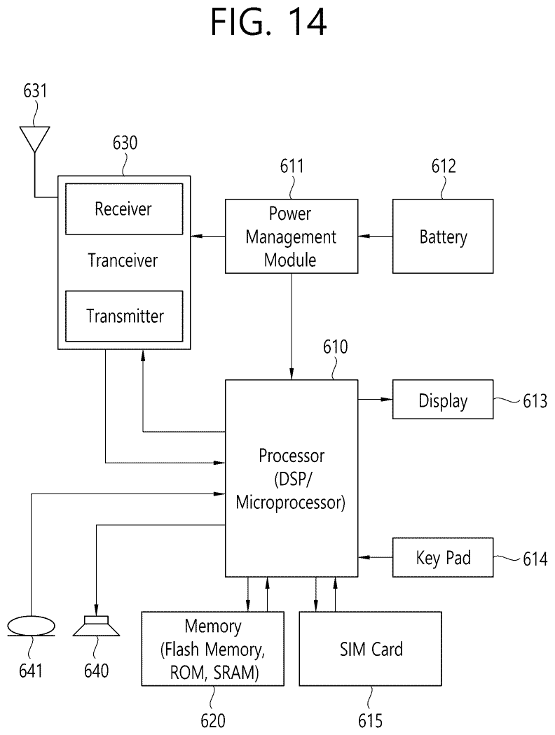

FIG. 14 illustrates a modified example of a transmitting device and/or receiving device of the present specification.

The devices (e.g., AP STAs, non-AP STAs) illustrated in FIGS. 1 to 4 may be modified as illustrated in FIG. 14. The transceiver (630) in FIG. 14 may be identical to the transceivers (113, 123) in FIG. 1. The transceiver (630) of FIG. 14 may include a receiver and a transmitter.

The processor (610) of FIG. 14 may be identical to the processors (111, 121) of FIG. 1. Alternatively, the processor (610) of FIG. 14 may be identical to the processing chip (114, 124) of FIG. 1.

The memory (150) of FIG. 14 may be identical to the memory (112, 122) of FIG. 1. Alternatively, the memory (150) of FIG. 14 may be a separate external memory different from the memory (112, 122) of FIG. 1.

Referring to FIG. 14, the power management module (611) manages power for the processor (610) and/or the transceiver (630). The battery (612) supplies power to the power management module (611). The display (613) outputs the results processed by the processor (610). The keypad (614) receives input to be used by the processor (610). The keypad (614) may be displayed on the display (613). The SIM card (615) may be an integrated circuit used to securely store an international mobile subscriber identity (IMSI) and associated keys, which are used to identify and authenticate subscribers in mobile devices such as mobile phones and computers.

Referring to FIG. 14, the speaker (640) may output sound-related results processed by the processor (610). The microphone (641) may receive sound-related input to be used by the processor (610).

The wireless LAN system described herein (e.g., IEEE 802.11bn or UHR system) is proposed to support ultra-high reliability (UHR) when transmitting signals to STA(s). To achieve this, various technologies are being considered, including high throughput, low latency, and extended range support. Based on these various technologies, it may be possible to extend the signal transmission range to not only improve reliability within the BSS but also expand the signal transmission coverage of the BSS. The following technical features relate to proposing a new structure (or type) of frame (or PPDU/preamble) for extended range (ER) communication in a wireless LAN system.

A device (e.g., non-AP STA, AP, non-AP MLD, AP, MLD) based on the present specification can support a new ELR (extended long range or enhanced long range) PPDU, designed to overcome link budget imbalances between the uplink and downlink and improve spectral efficiency for STAs operating far from the AP. The term ELR can be replaced with terms such as LR (long range) or ER (extended range). Accordingly, terms such as ER transmission or LR transmission can be expressed as ELR transmission. For example, in the example below, the LR PPDU can also be called ER PPDU or ELR PPDU. For example, the ELR PPDU has a fixed bandwidth of 20 MHz and can be used for both downlink and uplink in the 2.4 GHz band operation, but can be used only for uplink in the 5 GHz and 6 GHz band operation. In other words, the ELR PPDU may consist of only 20 MHz and may not have bandwidths such as 40/80/160/320 MHz.

As described above, in wireless LAN systems (e.g., IEEE 802.11bn or UHR systems), LR/ER/ELR communication can be considered to ensure smooth signal transmission and reception for STAs within the AP's coverage boundary and to overcome transmission range differences due to transmission power imbalance/differences between the AP and STAs. For example, the difference in transmission power between an AP and a non-AP STA may be approximately 10 dB. The link budget for received signals between the AP and non-AP STAs due to this TX power difference may be approximately 6 dB. For example, long-range transmission to provide a gain of 6 dB, the link budget difference, can be achieved using the following method.

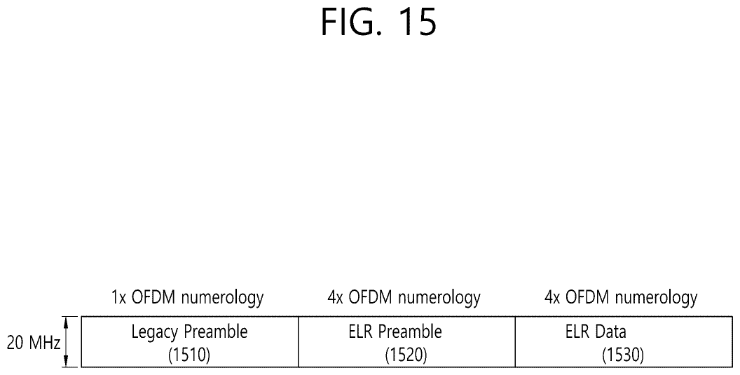

FIG. 15 illustrates an example of a PPDU proposed in the present specification. The example in FIG. 15 may be referred to by various names. For example, it may be referred to as an ELR PPDU, an ER PPDU, or an LR PPDU. It may also be referred to as a UHR PPDU, a UHR ELR PPDU, etc.

For example, the example of FIG. 15 can be generated to provide a 6 dB gain, which is the link budget difference described above. The example of FIG. 15 can be used for uplink, but can also be used for downlink (e.g., downlink within the 2.4 GHz band).

For example, the bandwidth of the example of FIG. 15 can be 40/80/160/320 MHz. However, considering that the example of FIG. 15 is used for ELR communication, it is preferable to transmit and receive based on a 20 MHz bandwidth. Therefore, to obtain additional gain (e.g., a 6 dB gain, which is the link budget difference), the example of FIG. 15 is preferably used for narrowband communication.

The example of FIG. 15 may include a legacy preamble (1510). For example, the legacy preamble (1510) may include L-STF, L-LTF, L-SIG, and U-SIG. For example, the legacy preamble (1510) may be configured based on 1× (OFDM) numerology. In other words, the subcarrier frequency spacing value of each field included in the legacy preamble (1510) may be 312.5 kHz. The name of the legacy preamble (1510) may be modified in various ways.

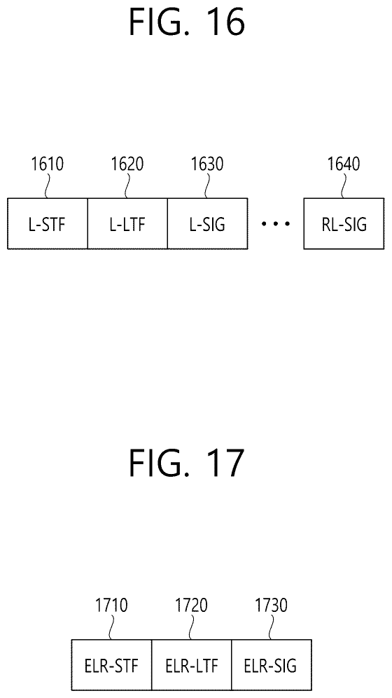

FIG. 16 illustrates an example of the legacy preamble (1510) of the present specification. As illustrated, the legacy preamble (1510) may include an L-STF (1610), an L-LTF (1620), an L-SIG (1630), and an RL-SIG (1640). Additionally, although not illustrated in FIG. 16, a U-SIG field contiguous to the RL-SIG (1640) may also be included.

For example, the L-STF (1610) and L-LTF (1620) illustrated in FIG. 16 may be configured based on the same sequence as the L-STF and L-LTF described in FIG. 5. Additionally or alternatively, power boosting of 3/4/5/6 dB may be applied to the L-STF (1610) and L-LTF (1620).

For example, the L-SIG (1630) illustrated in FIG. 16 may be repeated in the time domain. For example, the RL-SIG (1640) may be a repetition of the L-SIG (1630). While one L-SIG (1630) and one RL-SIG (1640) are illustrated in the PPDU of FIG. 16, additional RL-SIGs may be included. The RL-SIG (1640) may be contiguous to the L-SIG (1630). For example, power boosting of 3/4/5/6 dB may not be necessary for the L-SIG (1630) and the RL-SIG (1640). This is because the content of the L-SIG (1630) is repeated in the time domain.

For example, the L-SIG (1630) and the RL-SIG (1640) illustrated in FIG. 16 may be configured identically to the L-SIG and RL-SIG illustrated in FIG. 5.

For example, if an ELR PPDU is configured to include the RL-SIG (1640), a STA (e.g., a non-AP STA or AP) receiving the PPDU can determine that the received PPDU is an 11ax or higher version PPDU through an L-SIG repetition check. Furthermore, a value of length %3 for the RL-SIG (1640) can be used to determine whether the PPDU is an 11ax or 11be/UHR/next version.

In other words, the RL-SIG (1640) field is a repetition of the L-SIG (1630) field and is used to differentiate a UHR PPDU from a non-HT PPDU, an HT PPDU, and a VHT PPDU.

Additionally or alternatively, the legacy preamble (1510) may include a U-SIG, which may provide protection for legacy STAs (e.g., 11be or EHT STA(s)).

For example, the U-SIG included in the legacy preamble (1510) may be based on the U-SIG of FIG. 5. For example, the U-SIG included in the legacy preamble (1510) may be contiguous to the RL-SIG (1640), similar to the U-SIG of FIG. 5. The U-SIG included in the legacy preamble (1510) may include a 3-bit PHY version identifier (information/field), similar to the U-SIG of FIG. 5. The value of the PHY version identifier (information/field) may be set to one (1), indicating that the legacy preamble (1510) is related to a UHR PPDU. In other words, based on the value of the PHY version identifier (information/field) being set to one (1), it can be indicated that the received/transmitted PPDU is a UHR PPDU, an ELR PPDU, or a UHR ELR PPDU.

For example, the U-SIG included in the legacy preamble (1510) may include PPDU Type And Compression Mode (e.g., 2 bits), similar to the U-SIG of FIG. 5. For example, the 2-bit field/bit (e.g., PPDU Type And Compression Mode) may be used to indicate ELR transmission. Specifically, to ensure the same indication during DL and UL transmission, the value of the PPDU Type And Compression Mode may be set to 3.

For example, the U-SIG included in the legacy preamble (1510) may include TXOP information, similar to the U-SIG of FIG. 5. Accordingly, a STA (e.g., a non-AP or AP) that receives a PPDU (e.g., an ELR PPDU) including the legacy preamble (1510) can set a NAV based on the TXOP information if it is not the intended STA. This allows the STA to perform power saving (and/or protection against ELR transmissions in progress between other STAs).

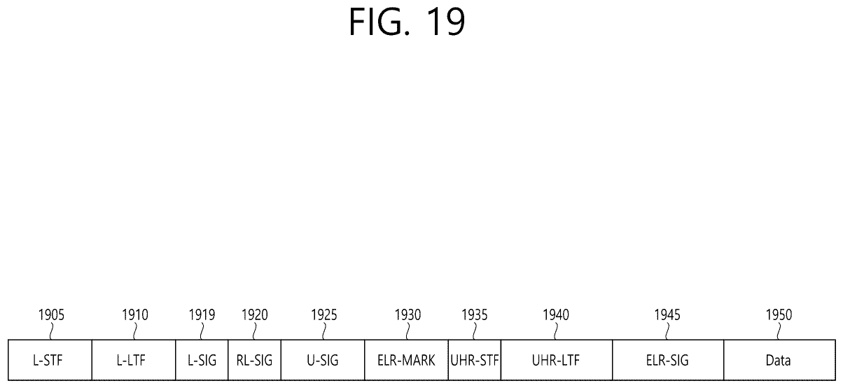

The U-SIG included in the legacy preamble (1510) (in other words, the U-SIG included in the ELR PPDU) may include various bits/subfields. More specific characteristics regarding the bits/subfields included in the U-SIG are described with reference to FIG. 19. That is, the U-SIG described in FIG. 19 may be identical to the U-SIG included in the legacy preamble (1510) (in other words, the U-SIG included in the ELR PPDU).

Hereinafter, the ELR preamble (1510) of FIG. 15 will be described with reference to FIG. 17.

FIG. 17 illustrates an example of multiple fields/subfields that may be included in the ELR preamble. For example, as illustrated in FIG. 15, the ELR preamble (1520) may be contiguous to the legacy preamble (1510). For example, as illustrated in FIG. 15, the multiple fields included in the ELR preamble (1520) may be configured based on 4× (OFDM) numerology, unlike the legacy preamble (1510). In other words, the subcarrier frequency spacing value of each field included in the ELR preamble (1520) may be 78.125 kHz. The name of the ELR preamble (1520) may be modified in various ways.

For example, the ELR preamble (1520) may include an ELR-STF (1710), an ELR-LTF (1720), and an ELR-SIG (1730). The ELR-STF (1710) may be contiguous to the ELR-LTF (1720), and the ELR-LTF (1720) may be contiguous to the ELR-SIG (1730). For example, the fields included in the ELR preamble (1520) may be limited to only the three fields (ELR-STF (1710), ELR-LTF (1720), and ELR-SIG (1730)) illustrated in FIG. 17.

For example, the ELR-STF (1710) may be configured based on the HE/EHT-STF. For example, the ELR-STF may be configured based on the following sequence:

$$UHRS\_ \{ - 112 : 16 : 112 \} = M \cdot ( 1 + j ) / ( √ 2 ) \qquad [ Equation 1 ]$$

The value of STF sequence at null tone index 0 is zero.

$$M = \{ - 1 , - 1 , - 1 , 1 , 1 , 1 , - 1 , 1 , 1 , 1 , - 1 , 1 , 1 , - 1 , 1 \}$$

As shown in Equation 1, the ERL-STF (1710) can be generated/configured/defined based on an STF sequence expressed in UHRS. For example, the lowest tone/subcarrier index of the STF sequence in Equation 1 is “−112,” and the highest tone/subcarrier index is “+112.” For example, the STF sequence in Equation 1 can have values/coefficients at 16 tone/subcarrier intervals. For example, the STF sequence in Equation 1 can be defined based on an M sequence, and the M sequence can be a sequence having 15 elements/values/coefficients, as shown in Equation 1.

For example, the ERL-STF (1710) can be configured to repeat a 0.8 μs sequence, similar to the legacy STF described in FIG. 5. Using the STF sequence configured as described above, the ELR-STF can be configured/defined/transmitted as 8 μs symbols.

For example, the ELR-STF (1710) can be modified in various ways. For example, a generated 0.8 μs sequence can be included/repeated five times, allowing the ELR-STF to be configured/defined/transmitted with 4 μs symbols.

While Equation 1 above illustrates an example where the value/coefficient is defined at a 16-tone/subcarrier interval, an 8-tone/subcarrier interval can be used instead. The 1.6 s sequence generated based on this can be repeated five or ten times, ultimately forming the ELR-STF (1710) based on an 8 μs or 16 μs duration. The above can be expressed mathematically as follows:

$$\begin{matrix}UHRS\_ \{ - 120 : 8 : 120 \} = \{ M , 0 , - M \} \cdot ( 1 + j ) / ( √ 2 ) \\ M = \{ - 1 , - 1 , - 1 , 1 , 1 , 1 , - 1 , 1 , 1 , - 1 , 1 , 1 , - 1 , 1 \}\end{matrix} \qquad [ Equation 2 ]$$

For example, the ELR-LTF (1710) can be configured based on the HE/EHT-LTF. For example, the ELR-LTF (1710) can be configured/defined/generated based on various LTF sequences. For example, the ELR-LTF (1710) can be based on a 4× LTF sequence among 1×, 2×, and 4× LTF sequences. Since the ELR PPDU is transmitted and received based on a single SS, if the ELR-LTF (1710) is configured/generated based on a 4× LTF sequence, the LTF can be composed of a single OFDM symbol.

For example, using a 4× LTF sequence is expected to improve channel estimation performance using LTFs because coefficients/values are defined for all frequency indices/tones. However, one example of the present specification suggests configuring the ELR-LTF (1710) based on a 2× LTF sequence. In a 2× LTF sequence, coefficients/values can only be defined for even frequency indices/tones. Performing a Fourier transform on this sequence can generate a signal in which the same sequence is repeated within a single symbol in the time domain. By transmitting this signal twice in the time domain across two symbols, the receiving STA can achieve sufficient channel estimation performance. Specifically, channel estimation performance can be improved by transmitting the repeated LTF signal across two 8 μs symbols, rather than just one 8 μs symbol generated based on the 2x LTF sequence.

For example, while coefficients/values in a 2× LTF sequence are not defined for all frequency indices/tones, interpolation can support channel estimation for odd indices/tones. Accordingly, by transmitting an 8 μs symbol generated based on a 2× LTF sequence twice (e.g., repeatedly transmitting in the temporal domain), a maximum-ratio combining (MRC) gain can be achieved compared to transmitting a 16 μs symbol based on a 4× LTF sequence once, thereby further improving channel estimation performance.

For example, the ELR-LTF (1710) can be configured based on various 2× LTF sequences.

For example, the ELR-LTF (1710) can be generated based on the following sequence:

$$2 x LTF = \{ - 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , - 1 , 0 , - 1 , 0 , + 1 , 0 , + 1 , 0 , - 1 , , + 1 , 0 , + 1 , 0 , + 1 , 0 , + 1 , 0 , + 1 , 0 , - 1 , 0 , + 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , + 1 , 0 , + 1 , 0 , + 1 , 0 , - 1 , 0 , - 1 , 0 , + , 0 , - 1 , 0 , - 1 , 0 , - 1 , 0 , - 1 , 0 , - 1 , 0 , - 1 , 0 , - 1 , 0 , + 1 , 0 , - 1 , 0 , - 1 , 0 , + 1 , 0 , - 1 , 0 , - 1 , 0 , + 1 , 0 , + 1 , 0 , + 1 , 0 , - 1 , 0 , - 1 , 0 , + 1 , 0 , 0 , 0 + 1 , 0 , - 1 , 0 , + 1 , 0 , + 1 , 0 , - 1 , 0 , + 1 , 0 , - 1 , 0 , + 1 , 0 , + 1 , 0 , - 1 , 0 , + 1 , 0 , + 1 , 0 , - 1 , 0 , + 1 , 0 , - 1 , 0 , + 1 , 0 , + 1 , 0 , - 1 , 0 , - 1 , 0 , + 1 , 0 , - 1 , 0 , - 1 , 0 , - 1 , 0 , - 1 , 0 , - 1 , 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , 0 , + 1 , 0 , - 1 , 0 , + 1 , 0 , - 1 , 0 , - 1 , 0 , - 1 , 0 , + 1 , 0 , - 1 , 0 , + 1 , 0 , - 1 , 0 , + 1 , 0 , - 1 , 0 , - 1 , 0 , - 1 , 0 , - 1 , 0 , - 1 , 0 , - 1 , 0 , + 1 , 0 , - 1 , 0 , + 1 \}$$

For the proposed ELR-LTF (1710), a GI of 3.2 μs is applied. For example, a GI of 3.2 μs is not required; a GI of 1.6 s, for example, can also be used.

Similar to the L-STF and L-LTF, power boosting of 3/4/5/6 dB can be applied to the ELR-STF (1710) and/or ELR-LTF (1720) described above. This allows the receiving STA to normally receive the ELR-STF (1710) and/or ELR-LTF (1720).

The ELR-SIG (1730) is described below.

For example, the ELR-SIG (1730) can be included in the ELR preamble (1520). For example, the ELR-SIG (1730) may follow the ELR-LTF (1720). In other words, the ELR-SIG (1730) may be contiguous to the ELR-LTF (1720).

For example, the ELR-SIG (1730) may be composed of two symbols. For example, the ELR-SIG (1730) may include various information related to ELR communication (e.g., various information for the data field and/or interpretation/decoding/demodulation of the ELR PPDU). Examples of various subfields/bits that may be included in the ELR-SIG (1730) are described in more detail in FIG. 19.

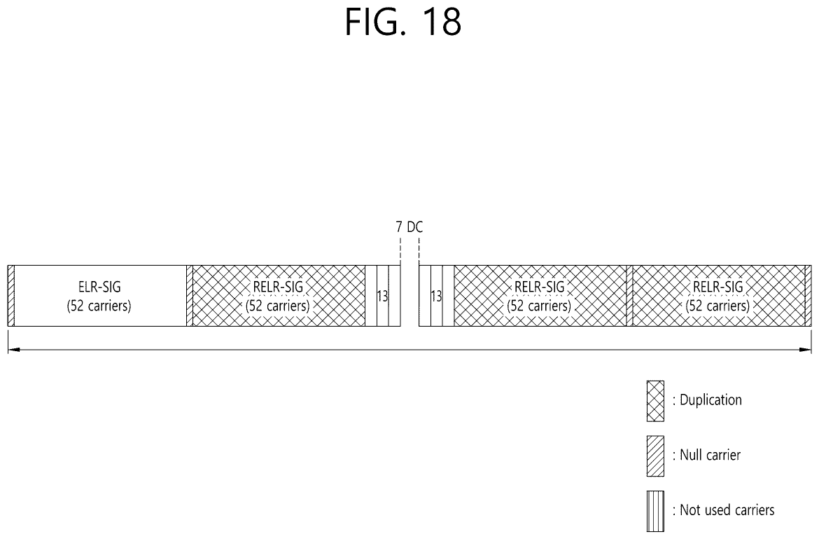

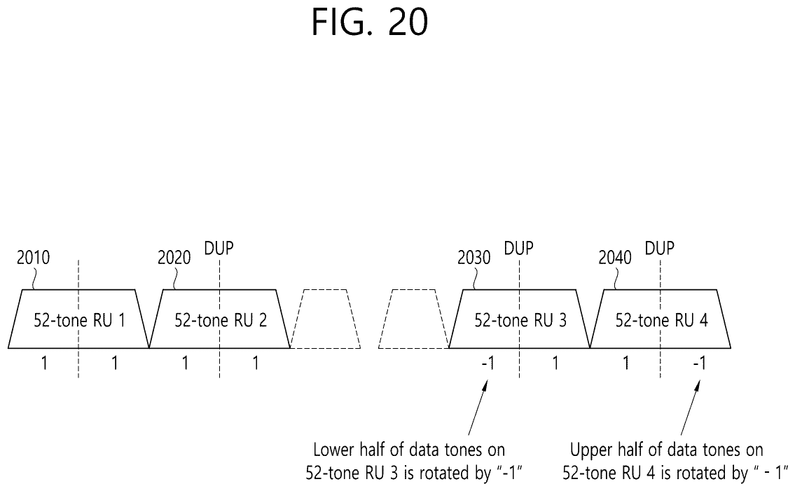

Preferably, duplication of the ELR-SIG (1730) in the present specification is performed in the frequency domain in units of 52-tone RUs/subcarriers, according to the following technique. For example, duplication in the frequency domain applied to the ELR-SIG (1730) is preferably applied identically to the ELR Data (1530). For example, the reference 52-tone RU used when duplication is performed in the frequency domain may be identical to the 52-tone RU defined in IEEE 802.11ax/be. More specific characteristics of this 52-tone RU can be described with reference to FIG. 18 and/or FIG. 20.

FIG. 18 describes duplication in the frequency domain applied to the ELR-SIG.

As illustrated, the ELR-SIG is duplicated in 52-tone RU units in the frequency domain. In other words, bit information transmitted and received through the ELR-SIG can be mapped to a single 52-tone RU. A single 52-tone RU is duplicated in the frequency domain. In the example of FIG. 18, the leftmost ELR-SIG can be duplicated through three repeated ELR-SIGs (RELR-SIGs). That is, all four 52-tone RUs shown in FIG. 18 can be used to transmit and receive the same bit information (e.g., identical contents). For example, in addition to the four 52-tone RUs shown in FIG. 18, the two 13-subcarriers and the seven DC tones may not be used for the ELR-SIG.

For example, the frequency mapping technique shown in FIG. 18 can be applied equally to ELR Data as well as ELR-SIG (1730).

For example, a limited MCS technique can be applied to the ELR-SIG (1730) and/or ELR Data fields to which the technique of FIG. 18 is applied. For example, only the MCS technique associated with the MCS0 index (BPSK with a ½ code rate) or only the MCS technique associated with a preset MCS index (e.g., MCS1) can be applied.

For example, DC or null subcarriers can be included between the four 52-tone RUs illustrated in FIG. 18. Alternatively, the four 52-tone RUs illustrated in FIG. 18 can be arranged consecutively/contiguously.

As described above, duplicating the ELR-SIG (1730) in the frequency domain based on 52 tones can achieve a link budget gain of 6 dB. Furthermore, the performance and reliability of the SIG field can be improved during long-range transmission.

FIG. 19 illustrates an example of an ELR PPDU of the present specification. As illustrated, an ELR PPDU (or a PPDU used for ELR communication) may include L-STF (1905), L-LTF (1910), L-SIG (1915), RL-SIG (1920), U-SIG (1925), ELR-MARK (1930), UHR-STF (1935), UHR-LTF (1940), ELR-SIG (1945), and Data (1950). For example, some fields in FIG. 19 may be omitted. For example, the order of some fields in FIG. 19 may be changed. Each field disclosed in FIG. 19 may be referred to by various names, such as “signal” or “bit.”

The PPDU and/or fields in FIG. 19 are further specific examples of the examples in FIGS. 15 to 18. Accordingly, the technical features applied to FIG. 19 may include the technical features applied to the examples of FIGS. 15 to 18.

For example, L-STF (1905) to ELR-MARK (1930) of FIG. 19 may be included in Legacy Preamble (1510) of FIG. 15. For example, L-STF (1905) to RL-SIG (1920) of FIG. 19 may be identical to L-STF (1610) to RL-SIG (1640) of FIG. 16. For example, U-SIG (1925) of FIG. 19 may be identical to the U-SIG included in FIGS. 15 and/or 16.

The UHR-STF (1935), UHR-LTF (1940), and ELR-SIG (1945) of FIG. 19 may be included in the ELR Preamble (1520) of FIG. 15. In other words, the UHR-STF (1935) of FIG. 19 may be identical to the ELR-STF (1710) described above. In other words, the UHR-LTF (1940) of FIG. 19 may be identical to the ELR-LTF (1920) described above. In other words, the ELR-SIG (1945) of FIG. 19 may be identical to the ELR-SIG (1730) of FIG. 17.

The Data (1950) of FIG. 19 may be identical to the ELR Data (1530) of FIG. 15.

As described above, the value of the number of spatial streams (e.g., Nss) for the ELR PPDU of the present specification may be limited to 1. Additionally or alternatively, for example, the ELR PPDU has a fixed bandwidth of 20 MHz and can be used for both downlink and uplink in 2.4 GHz band operation, but only for uplink in 5 GHz and 6 GHz band operation. In other words, the ELR PPDU may consist of only 20 MHz and may not have bandwidths such as 40/80/160/320 MHz.

For example, the ELR-MARK (1930) of FIG. 19 may consist of two OFDM symbols. The ELR-MARK (1930) may include information regarding an identifier (e.g., BSS_COLOR) indicating the BSS color to which the STA transmitting the corresponding PPDU belongs.

For convenience of explanation, the technical characteristics of the ELR PPDU are described in detail below, focusing on the four fields/signals (1925, 1940, 1945, and 1950).

For example, the U-SIG (1925) of the present specification may have the following characteristics. For example, the U-SIG (1925) of the present specification may be composed of signals/fields for the ELR PPDU. For example, while non-ELR PPDU PPDUs (e.g., UHR MU PPDU or UHR TB PPDU) also include the U-SIG, the contents of the U-SIG (1925) of the present specification may include different contents.

For example, the U-SIG (1925) of the present specification has a length of two symbols, and each symbol may be represented as U-SIG-1 and U-SIG-2. For example, the B0 to B2 bits of U-SIG-1 may have various names, such as the first information described above or the PHY Version Identifier, and may include a value (e.g., a value of 1) identifying the PHY version of the PPDU as UHR. For example, the positions of the B0 to B2 bits may be changed.

Additionally or alternatively, the B3 to B5 bits of U-SIG-1 may have various names, such as the second information or BW information, and may include information regarding the bandwidth of the ELR PPDU. For example, the B3 to B5 bits of U-SIG-1 may only have a value of 0, as the bandwidth of the ELR PPDU is preferably fixed to 20 MHz. For example, the positions of the B3 to B5 bits may be changed.

Additionally or alternatively, the B6 bit of U-SIG-1 may include information regarding whether the PPDU is transmitted in the UL or DL. For example, the position of the B6 bit may be changed.

Additionally or alternatively, bits B7 through B12 of U-SIG-1 may indicate the ID of a Basic Service Set (BSS). For example, bits B7 through B12 may include ID information (or BSS color information) of the BSS to which the STA transmitting/receiving the corresponding PPDU belongs. For example, the positions of bits B7 through B12 may be changed.

Additionally or alternatively, bits B13 through B19 of U-SIG-1 may include information related to the duration of a transmission opportunity (TXOP). For example, the positions of bits B13 through B19 may be changed.

Additionally or alternatively, bits B20 through B24 of U-SIG-1 may all be set to 1, and the corresponding bits may be referred to as disregarded. For example, the positions of bits B20 through B24 may be changed.

Additionally or alternatively, the B25 bit of U-SIG-1 may be set to 1 and may be called “Validate.” For example, the position of the B25 bit may be changed.

Additionally or alternatively, the B0 bit and the B1 bit of U-SIG-2 may have various names, such as the third information or “PPDU Type And Compression Mode.” The B0 bit and the B1 bit may always have a value of three regardless of whether the associated PPDU is a DL PPDU or an UL PPDU, thereby indicating/identifying that the PPDU is an ELR PPDU. For example, the positions of the B0 bit and the B1 bit may be changed.

Additionally or alternatively, the B2 bit and the B12 bit of U-SIG-2 may be configured as a STA ID. For example, bits B2 through B12 may be configured as 11 bits (e.g., 11 bits of the LSB or 11 bits of the MSB) of the Association ID (AID) of the STA transmitting the corresponding PPDU. For example, the positions of bits B2 through B12 may be changed.

Additionally or alternatively, bits B13 through B15 of the U-SIG-2 may be configured as ER/ELR validate. These three bits may be used to identify an ELR PPDU, and all three bits may be set to 1 (i.e., the three bits may have a value of 7). For example, the positions of bits B13 through B15 may be changed.

Additionally or alternatively, bits B16 through B19 of the U-SIG-2 may be configured as a CRC.

Additionally or alternatively, bits B20 to B25 of U-SIG-2 may be configured as a tail, with all bits set to zero.

For example, U-SIG1 and U-SIG2 may be repeated in the time domain based on at least one of FIGS. 15 to 18.

For example, the UHR-LTF (1940) may have the following characteristics. The UHR-LTF (1940) may be divided into signals for ELR communication and signals for non-ELR communication.

Additionally or alternatively, the UHR-LTF for ELR communication may be configured based on a 2× LTF sequence. The 2× LTF sequence may be defined in the range of indices −122 to +122. The sequence may be expressed as follows:

$$2 x LTF = \{ - 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , - 1 , 0 , - 1 , 0 , + 1 , 0 , + 1 , 0 , - 1 , , + 1 , 0 , + 1 , 0 , + 1 , 0 , + 1 , 0 , + 1 , 0 , - 1 , 0 , + 1 , 0 , - 1 , 0 , - 1 , 0 , + 1 , 0 , + 1 , 0 , - 1 , 0 , + 1 , 0 , - 1 , 0 , - 1 , 0 , - 1 , 0 , - 1 , 0 , + 1 , 0 , - 1 , 0 , + 1 , 0 , + 1 , 0 , + 1 , 0 , - 1 , 0 , - 1 , 0 , + , 0 , - 1 , 0 , - 1 , 0 , - 1 , 0 , - 1 , 0 , - 1 , 0 , - 1 , 0 , - 1 , 0 , + 1 , 0 , - 1 , 0 , - 1 , 0 , + 1 , 0 , - 1 , 0 , - 1 , 0 , + 1 , 0 , + 1 , 0 , + 1 , 0 , - 1 , 0 , - 1 , 0 , + 1 , 0 , 0 , 0 + 1 , 0 , - 1 , 0 , + 1 , 0 , + 1 , 0 , - 1 , 0 , + 1 , 0 , - 1 , 0 , + 1 , 0 , + 1 , 0 , - 1 , 0 , + 1 , 0 , + 1 , 0 , - 1 , 0 , + 1 , 0 , - 1 , 0 , + 1 , 0 , + 1 , 0 , - 1 , 0 , - 1 , 0 , + 1 , 0 , - 1 , 0 , - 1 , 0 , - 1 , 0 , - 1 , 0 , - 1 , 0 , - 1 , 0 , - 1 , 0 , + 1 , 0 , - 1 , 0 , + 1 , 0 , - 1 , 0 , + 1 , 0 , + 1 , 0 , - 1 , 0 , - 1 , 0 , + 1 , 0 , - 1 , 0 , + 1 , 0 , - 1 , 0 , - 1 , 0 , - 1 , 0 , + 1 , 0 , - 1 , 0 , + 1 , 0 , - 1 , 0 , + 1 , 0 , - 1 , 0 , - 1 , 0 , - 1 , 0 , - 1 , 0 , - 1 , 0 , - 1 , 0 , + 1 , 0 , - 1 , 0 , + 1 \}$$

For example, not all elements (or values) of the above 2× LTF sequence may be used. For example, among the elements (or values) of the above 2× LTF sequence, elements that do not correspond to the 52-tone RUs (1610, 1620, 1630, 1640) that are duplicated four times as in FIG. 16 may be replaced with zero. In other words, ELR transmission may use the above 2× LTF sequence in 20 MHz, but only populates subcarriers corresponding to four 52-tone RUs in 20 MHz. For unpopulated subcarriers, the values of the 2× LTF sequence may be replaced by zero.

For example, a power boost of 3/4/⅚ dB may be applied to the UHR-LTF (1940) so that it has a power level similar to that of the L-LTF (1910).

For example, the ELR-SIG (1945) may have the following characteristics. For example, the ELR-SIG (1945) of the present specification may have two parts. Each part may be designated as ELR-SIG-1 and ELR-SIG-2. For example, the B0 bit of ELR-SIG-1 may include the first ER/ELR-SIG information described above or the ELR Version Identifier. For example, the B0 bit of the ELR-SIG-1 may contain information identifying the ELR version, and the ELR Version Identifier included in an ELR PPDU having the technical features described herein may have a value of 0. For example, the position of the B0 bit may be changed.

Additionally or alternatively, the B1 bit of the ELR-SIG-1 may contain a UL/DL field. For example, this bit may contain information regarding whether the ELR PPDU is transmitted in UL/DL. For example, the position of the B1 bit may be changed.

Additionally or alternatively, the B2 bit of the ELR-SIG-1 may contain an MCS field. For example, this bit may contain information related to MCS information applied to the data field of the ELR PPDU. For example, if this bit is set to a first value (e.g., 0), this bit may indicate that BPSK with a coding rate of ½ is applied to the data field of the ELR PPDU. For example, if the bit is set to a second value (e.g., 1), the bit may indicate that QPSK with a coding rate of ½ is applied to the data field of the ELR PPDU. For example, the position of B2 may be changed.

Additionally or alternatively, the B3 bit of the ELR-SIG-1 may include a coding (type) field. For example, the bit may include information related to the coding (type) information applied to the data field of the ELR PPDU. For example, if the bit is set to a first value (e.g., 0), the bit may indicate that the BCC technique is applied to the data field of the ELR PPDU. For example, if the bit is set to a second value (e.g., 1), the bit may indicate that the data field of the ELR PPDU uses an LDPC technique (e.g., an LDPC with a word length of 648, 1296, or 1944).

Additionally or alternatively, bits B4 through B12 of the ELR-SIG-1 may include a length field. For example, the length field may be 9 bits long, and the specific bit positions may be variable. For example, this field may include information regarding the number of symbols in the data field included in the ELR PPDU.

Additionally or alternatively, bit B13 of the ELR-SIG-1 may include information regarding the presence of an LDPC extra (OFDM) symbol. For example, this information may include information regarding whether additional OFDM symbols are required for LDPC encoding the PPDU.

Additionally or alternatively, bits B14 through B17 of ELR-SIG-1 may include CRC bits, and bits B18 through B23 of ELR-SIG-1 may include tail bits and have a value of 0.

Additionally or alternatively, bits B0 through B10 of ELR-SIG-2 may include information regarding the STA-ID. For example, these bits may be comprised of 11 bits (e.g., 11 bits of the LSB or 11 bits of the MSB) of the AID of the STA transmitting the ELR PPDU. For example, the positions of these bits may be changed.

Additionally or alternatively, bits B1 through B13 of ELR-SIG-2 may include a disregard field/information. Each bit of this 3-bit field/information may be set to 1.

Additionally or alternatively, bits B14 through B17 of ELR-SIG-2 may include CRC bits, and bits B18 through B23 of ELR-SIG-1 may include tail bits and have a value of 0.

For example, the Data (1950) field may be referred to by various names, such as ER/ELR-Data, Payload, etc. The Data (1950) field and ELR-SIG (1945) of the present specification may be transmitted via four duplicated 52-tone RUs, as described below.

For example, each of the ELR-SIG-1 and ELR-SIG-2 bits included in ELR-SIG (1945) may include 24 bits of information (e.g., uncoded bits having a length of 24 bits). For information of 24 bits in length (e.g., uncoded bits of 24 bits in length), BCC encoding using a ½ code rate can be applied to generate coded bits of 48 bits in length. BPSK modulation can be applied to the coded bits to generate 48 BPSK symbols corresponding to ELR-SIG-1 and ELR-SIG-2, respectively. Four pilots are added to these 48 BPSK symbols, generating data corresponding to a total of 52 subcarriers/tones, which are included in a 52-tone RU. This 52-tone RU can be transmitted through a 52-tone RU that is duplicated/repeated four times in the frequency domain according to the method described herein (or through four duplicated 52-tone RUs).

For example, the information contained in Data (1950) can be mapped to a 52-tone RU based on BPSK or QPSK modulation.

An example of configuring four duplicated 52-tone RUs is described below. The example of FIG. 20 described below is a more detailed version of the example of FIG. 19 described previously.

FIG. 20 is a diagram illustrating four 52-tone RUs included in an ELR PPDU.

As illustrated, at least one of the ELR-SIG (1945) and/or Data (1950) fields of an ELR PPDU can be transmitted and received via four 52-tone RUs (2010, 2020, 2030, 2040). The illustrated 52-tone RUs (2010, 2020, 2030, 2040) can be included in a 20 MHz ELR PPDU.

For example, based on the aforementioned technique, encoding of at least one of the ELR-SIG (1945) and/or Data (1950) can be performed for the 52-tone RU (2010). The 52-tone RU (2010) may be duplicated into three 52-tone RUs (2020, 2030, 2040) within a 20 MHz PPDU. In other words, the ELR-SIG and data fields may be transmitted over the 52-tone RU with four duplications in the frequency domain across four 52-tone RUs in 20 MHz.

Additionally or alternatively, phase rotation may be performed on the four 52-tone RUs (2010, 2020, 2030, 2040).

Additionally or alternatively, a phase rotation of “−1” may be applied to the lower half of the third 52-tone RU (2030). Additionally or alternatively, a phase rotation of “−1” may be applied to the lower half of the data subcarriers of the third 52-tone RU (2030). For example, the lower half of the 52-tone RU (2030) may refer to the 26 subcarriers with the lowest indices among the 52 subcarriers of the 52-tone RU (2030) (e.g., data tones with a subcarrier index range of [43:68]).

Additionally or alternatively, a phase rotation of “−1” may be applied to the upper half of the fourth 52-tone RU (2040). Additionally or alternatively, a phase rotation of “−1” may be applied to the upper half of the data subcarriers of the fourth 52-tone RU (2030). For example, the upper half of the 52-tone RU (2040) may refer to the 26 subcarriers with the highest indices among the 52 subcarriers of the 52-tone RU (2040) (e.g., data tones with a subcarrier index range of [96:121]).

For example, in the example of FIG. 20, the first 52-tone RU (2010) may be located within the index range of [−121: −70]. For example, within the [−121: −70] index range, a 4-tone pilot sequence may be inserted into the {-116, −102, −90, −76} indices, and a data subcarrier may be allocated to the remaining 48 tones. The 48-tone data subcarrier may include information for the ELR-SIG (1945) and/or Data (1950) fields.

For example, in the example of FIG. 20, the second 52-tone RU (2020) may be located within the [−68: −17] index range. For example, within the [−68: −17] index range, a 4-tone pilot sequence may be inserted into the {-62, −48, −36, −22} indices, and a data subcarrier may be allocated to the remaining 48 tones. The data subcarrier of the 48-tone signal may include information for the ELR-SIG (1945) and/or Data (1950) fields.

For example, in the example of FIG. 20, the third 52-tone RU (2030) may be located within the index range of [17:68]. For example, within the [17:68] index range, a 4-tone pilot sequence may be inserted into the {22, 36, 48, 62} indices, and the data subcarrier may be allocated to the remaining 48 tones. The data subcarrier of the 48-tone signal may include information for the ELR-SIG (1945) and/or Data (1950) fields. For example, the [17:42] index range of the third 52-tone RU (2030) corresponds to the lower half, and thus a phase rotation of “−1” may be applied. More specifically, a phase rotation of “−1” may be applied to the remaining 24 tones, excluding the pilot index {22, 36}, within the [17:42] index range.

For example, in the example of FIG. 20, the fourth 52-tone RU (2040) may be located within the index range of [70:121]. For example, within the index range of [70:121], a 4-tone pilot sequence may be inserted into the {76, 90, 102, 116} indices, and data subcarriers may be allocated to the remaining 48 tones. The 48-tone data subcarriers may include information for the ELR-SIG (1945) and/or Data (1950) fields. For example, in the fourth 52-tone RU (2040), the index range [96:121] corresponds to the upper half, and thus a phase rotation of “−1” can be applied. More specifically, a phase rotation of “−1” can be applied to the remaining 24 tones within the index range [96:121], excluding the pilot index {102, 116}.

For example, the above-mentioned indices or index ranges can be subject to subcarrier subspacing of 78.125 kHz. In other words, a difference in one index (or frequency index, subcarrier index, or tone index) can mean a difference of 78.125 kHz in the frequency domain.

Examples of the present specification can address problems of the prior art from various perspectives. For example, the present specification proposes an optimized location of the ELR-SIG associated with ELR transmission and reception. According to an example of the present specification, the ELR-SIG is located in the ELR Preamble (1520) of FIG. 15, which is configured based on 4× (OFDM) numerology, and may be located immediately after the ELR-STF (1710) and the ELR-LTF (1720). Similar to the UHR PPDU and/or the EHT PPDU, the ELR PPDU has an RL-SIG and a U-SIG, which may be used to distinguish the ELR PPDU format from other PPDU formats. However, it may be difficult to distinguish the ELR PPDU format with only the RL-SIG and/or the U-SIG. For example, a problem may occur in which the L-SIG, the RL-SIG, and/or the U-SIG included in the ELR PPDU are not accurately decoded by the receiving STA due to power imbalance of the UL and DL. For example, L-STF and L-LTF included in an ELR PPDU can be normally decoded and received at a receiving STA through a power boost of 3 to 6 dB. However, considering the existing PPDU transmission and reception structure, it is known that the power headroom is small for fields after the L-SIG field. Considering backward compatibility, etc., it may be desirable to include L-SIG, RL-SIG, and/or U-SIG fields similar to those in a conventional PPDU in the ELR PPDU. However, if L-SIG, RL-SIG, and/or U-SIG fields with a structure similar to that in the conventional one are included in the ELR PPDU, a problem may occur in which the receiving STA normally decodes only L-STF and L-LTF and cannot perform normal decoding for the L-SIG, RL-SIG, and/or U-SIG fields.

Considering these points, it is necessary to propose an additional signal field to ensure that the receiving STA (e.g., non-AP or AP) can properly decode the ELR PPDU even when the L-SIG, RL-SIG, and/or U-SIG fields fail to decode properly. One example of such an additional signal field is the ELR-SIG proposed in the present specification.

The ELR-SIG proposed in the present specification can be duplicated in the frequency domain in the same manner as the ELR Data field (e.g., the ELR Data field in FIG. 15) to overcome the power imbalance problem between the UL and DL. For example, since the ELR-SIG in the present specification is transmitted in the frequency domain via a total of four 52-tone RUs, normal decoding at the receiving STA can be guaranteed despite the aforementioned power imbalance problem.

In this case, to duplicate the ELR-SIG in the frequency domain in the same manner as the Data field, it is desirable to apply the same OFDM numerology to the Data field. In other words, as with the Data field, it is desirable to apply a subcarrier frequency spacing of 78.125 kHz to the ELR-SIG.

Furthermore, it is desirable for the ELR-SIG to be located immediately after the ELR-STF and ELR-LTF. The ELR-STF allows the receiving STA to perform synchronization, automatic gain control (AGC), and compensation for carrier frequency offset (CFO), while the ELR-LTF allows the receiving STA to perform channel estimation. By placing the ELR-SIG immediately after the ELR-STF and ELR-LTF, more accurate decoding can be achieved using these two methods.

If the ELR-SIG (or a field performing a similar function) is located in the Legacy preamble (1510) in FIG. 15, it would be difficult to transmit using a total of four 52-tone RUs in the frequency domain due to the reliance on 1× OFDM numerology. In other words, if the ELR-SIG is generated based on 1× OFDM numerology, it is difficult to resolve the aforementioned power imbalance problem. Of course, a technical approach to overcome the power imbalance problem described above could be considered, such as generating the ELR-SIG based on 1× OFDM numerology and repeating it in the time domain. However, repeating the fields included in the Legacy Preamble (1510) in the time domain increases the temporal overhead.

Considering this, the ELR-SIG proposed in the present specification is preferably located in the ELR Preamble (1520) of FIG. 15, which is based on 4× (OFDM) numerology, immediately following the ELR-STF (1710) and ELR-LTF (1720). In this case, the ELR Data (1530) may be contiguous to the ELR-SIG, and the ELR-SIG preferably includes various information necessary for decoding the ELR Data (e.g., MCS information and coding type fields related to the data field). In addition, since it is desirable for ELR-SIG to include information necessary to interpret/decode ELR PPDU even when normal reception of L-SIG, RL-SIG, and/or U-SIG fields fails, in addition to information related to MCS and coding type, it may additionally include information such as a) 1-bit information about ELR PPDU and whether ELR PPDU is transmitted in UL/DL, b) 1-bit ELR Version Identifier, c) length field, and/or d) STA-ID. The specific configuration of ELR-SIG has already been described in detail through FIG. 19, etc.

In other words, the ELR PPDU of the present specification does not perform additional repetition in the time domain for the existing L-SIG, RL-SIG, and U-SIG despite the power imbalance problem. Accordingly, one L-SIG, one RL-SIG, and one U-SIG can be configured in one ELR PPDU of the present specification based on the existing 1× OFDM numerology. However, the ELR PPDU of the present specification proposes a new structure in which it is transmitted a total of four times in the frequency domain immediately after the ELR-STF (1710) and ELR-LTF (1720) configured based on 4× (OFDM) numerology so that the ELR-SIG can be accurately decoded at the receiving STA while solving the power imbalance problem. The ELR-SIG may include once more some of the information that was included in the existing L-SIG, RL-SIG, and/or U-SIG fields. This is because even if the L-SIG, RL-SIG, and/or U-SIG fields are not properly decoded by the receiving STA, normal decoding/interpretation of the ELR PPDU is possible through the ELR-SIG field.

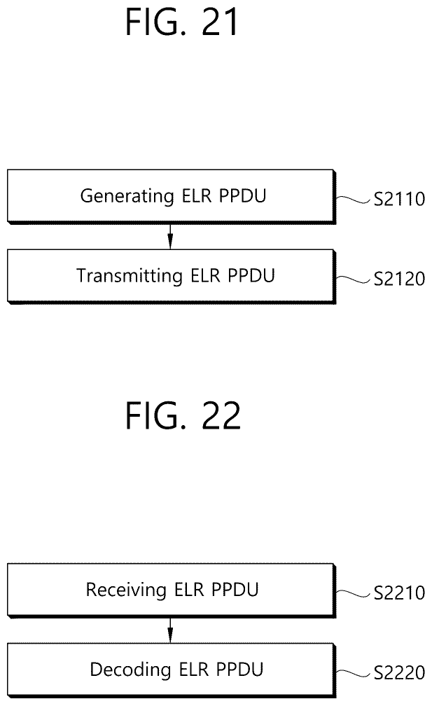

FIG. 21 is an example of a procedure flowchart related to the present specification. The procedure illustrated in FIG. 21 may be performed by a non-AP STA, a non-AP MLD, an AP (Access Point), or an AP MLD (AP Multi-link Device).

As illustrated in step S2110, a STA (e.g., a non-AP or AP) may generate (or configure, construct) an LR/ELR PPDU. For example, the ELR PPDU of step S2110 may be an ELR PPDU related to FIGS. 15 to 20.

For example, the ELR PPDU may include a legacy signal (L-SIG) field, a repeated L-signal (RL-SIG) field that is a repetition of the L-SIG field, and a universal signal (U-SIG) field that includes information necessary for interpreting the ELR PPDU. The L-SIG field, the RL-SIG field, and the U-SIG field may be generated based on a first subcarrier frequency spacing (or 1× OFDM numerology).

For example, the ELR PPDU may further include a short training field (STF), a long training field (LTF), an ELR signal (ELR-SIG) field, and a data field. The STF, the LTF, the ELR-SIG field, and the data field may be generated based on a second subcarrier frequency spacing (or 4× OFDM numerology).

For example, the STF may be referred to by various names, such as ELR/UHR-STF (e.g., UHR ELR STF). For example, the LTF may be referred to by various names, such as ELR/UHR-LTF (e.g., UHR ELR LTF). The data field may be referred to by various names, such as ELR data field, UHR data field, UHR-ELR data field, etc.

For example, the ELR-SIG field may be transmitted and received through four 52-tone resource units (RUs) duplicated in the frequency domain in units of 52-tone RUs.

For example, the ELR PPDU may have a bandwidth of 20 MHz.

For example, the RL-SIG field may be contiguous to the L-SIG field, and the U-SIG field may be contiguous to the RL-SIG field. In other words, the L-SIG field can be transmitted and received via the first symbol, the RL-SIG field via the second symbol, and the U-SIG field via the third and fourth symbols, and the first to fourth symbols can be contiguous to each other.

For example, the LTF can be contiguous to the STF, and the ELR-SIG field can be contiguous to the LTF.

For example, the first subcarrier frequency spacing (e.g., 312.5 kHz) may be four times the second subcarrier frequency spacing (e.g., 78.125 kHz).

As described above, the U-SIG may include two parts (e.g., U-SIG1 and U-SIG2). For example, the first part (U-SIG1) of the two parts may include a first field related to the PPDU Type and Compression Mode that identifies that the PPDU is an ELR PPDU, and the first field may have a value of three (3). For example, the second symbol of the two symbols may include a validate field that identifies that the PPDU is an ELR PPDU, the validate field may have a length of three bits, and the validate field may have a value of seven (7).

For example, the U-SIG field may further include various bits (e.g., various information/fields defined in U-SIG1 or U-SIG2).

For example, the ELR PPDU associated with step S2110 may further include an LTF (long training field) signal. Additionally or alternatively, the LTF signal may be based on the 2× LTF sequence described herein.

For example, the ELR-SIG (or UHR-SIG) may include information regarding the index of the modulation and coding scheme (MCS) applied to the data field (e.g., the ELR Data field). For example, the MCS applied to the data field may relate to either Binary Phase-Shift Keying (BPSK) or Quadrature Phase Shift Keying (QPSK). For example, the ER-SIG field may further include second information regarding the coding type applied to the data field, and the second information may have a length of 1 bit. For example, the ER-SIG field may further include third information regarding whether additional OFDM (Orthogonal Frequency-Division Multiplexing) symbols are required for LDPC (Low-Density Parity-Check) coding of the PPDU, and the third information may have a length of 1 bit.

For example, the data field (and/or the ER/ELR-SIG field) may be transmitted via multiple 52-tone resource units (RUs) in which a 52-tone RU is duplicated in the frequency domain. In other words, the data field (and/or the ER/ELR-SIG field) may be transmitted via multiple 52-tone RUs (e.g., four 52-tone RUs) in which a 52-tone RU is duplicated in the frequency domain. For example, the data field and/or the ER/ELR-SIG field may be transmitted and received based on an RU having a structure as in FIG. 20 (e.g., a duplicated/repeated 52-tone RU).

For example, the data field and/or the ER/ELR-SIG field may be transmitted based on four 52-tone RUs that are duplicated in the frequency domain (e.g., in units of 52-tone RUs). In this case, the four 52-tone RUs may be sequentially positioned in the frequency domain, from the first 52-tone RU to the fourth 52-tone RU, and a phase rotation of minus one (−1) may be applied to a tone in the lower half of the third 52-tone RU, and a phase rotation of minus one (−1) may be applied to a tone in the upper half of the fourth 52-tone RU. In this case, one (1) phase rotation may be applied to the first 52-tone RU and the second 52-tone RU, one (1) phase rotation may be applied to the upper half of the tones in the third 52-tone RU, and one (1) phase rotation may be applied to the lower half of the tones in the fourth 52-tone RU.

As illustrated in S2120 of FIG. 21, a STA (e.g., a non-AP or AP) may transmit a PPDU. For example, the PPDU may be transmitted via a single spatial stream. For example, the RU through which the PPDU is transmitted may be based on a 52-tone RU that is duplicated/repeated as described above.

FIG. 22 is an example of a procedure flowchart related to the present specification. The procedure illustrated in FIG. 22 may be performed by a non-AP STA, a non-AP MLD, an AP (Access Point), or an AP MLD (AP Multi-link Device).

As illustrated in step S2210, a STA (e.g., a non-AP or AP) may receive an ELR PPDU. For example, the ELR PPDU of step S2210 may be identical to the ELR PPDU of step S2110. Accordingly, technical features applicable to step S2110 may also be applied to step S2210. In other words, the STA may receive an ELR PPDU related to step S2110 through step S2210. Accordingly, any redundant description of step S2210 will be omitted.

As illustrated in S2220, a STA (e.g., a non-AP or an AP) can decode an ELR PPDU received through step S2110. For example, the STA can decode a data field (e.g., an ELR Data field) of the PPDU based on information in a U-SIG field and/or information in an ELR-SIG field included in the PPDU. For example, the STA of the present specification can decode a data field (e.g., an ELR Data field) of the PPDU based on information in the ELR-SIG field even if it fails to normally decode the U-SIG field.

The technical features of the present specification can be implemented by various devices. The devices of the present specification can be the devices described in FIG. 1/FIG. 14. The devices of the present specification include at least one processor; And it may include at least one computer memory operably connectable to the at least one processor and storing instructions that perform operations based on execution by the at least one processor.

For example, the processor may be the processor described in FIG. 1 and/or FIG. 14. Specifically, as described above, the processor of the present disclosure may include at least one of a digital signal processor (DSP), a central processing unit (CPU), a graphics processing unit (GPU), and a modem (modulator and demodulator). The processor may include computers with various architectures, such as single/multiprocessor architectures, sequential (Von Neumann)/parallel architectures, as well as specialized circuits such as FPGAs, application-specific integrated circuits (ASICs), signal processing devices, and other devices. For example, the processor described herein may be a SNAPDRAGON® series processor manufactured by Qualcomm®, an EXYNOS® series processor manufactured by Samsung®, an A series processor manufactured by Apple®, a HELIO® series processor manufactured by MediaTek®, an ATOM® series processor manufactured by INTEL®, or an enhanced processor thereof.

For example, the instructions may refer to computer program instructions executed by the at least one processor. The (computer program) instructions provide logic and/or routines that enable the technical features of the present disclosure to be performed by the processor. The at least one processor can load and execute a computer program by reading the at least one memory.

The computer program(s) defined by the instructions may arrive at the device (e.g., a STA) described herein via a suitable delivery mechanism. The transmission mechanism may be, for example, a computer-readable storage medium, a computer program product, a memory device, a recording medium such as a CD-ROM or DVD, or a product tangibly embodying a computer program. The transmission mechanism may be a signal configured to reliably transmit a computer program via a wireless or electrical connection.

The (computer program) instructions may include software or firmware for a programmable processor (e.g., programmable content of a hardware device, whether instructions for a processor, or configuration settings for a fixed-function device, gate array, or programmable logic device, etc.).

For example, the memory may be the memory described in FIG. 1 and/or FIG. 14. That is, as described above, the memory of the present specification may store control information related to the operation of the STA of the present specification or information regarding signals transmitted and received by the STA (e.g., PPDUs including management/control/data frames).

The technical features of the present specification may also be implemented in at least one computer-readable medium (CRM). The CRM includes instructions that are executed by at least one processor as described above. The instructions stored in the CRM may be computer program instructions as described above.

The device of the present disclosure may further include a transceiver. The transceiver may be operably connected to the memory/processor, etc. The transceiver may be the transceiver illustrated in FIG. 1 and/or FIG. 14.

The technical features of the disclosure described above are applicable to a variety of applications or business models. For example, the technical features described above may be applied for wireless communication in devices that support artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

What is claimed is:

1. A method, comprising;
generating an Enhanced Long Range (ELR) physical protocol data unit (PPDU); and
transmitting the ELR PPDU,
wherein the ELR PPDU includes a legacy signal (L-SIG) field, a repeated L-SIG (RL-SIG) which is a repeat of the L-SIG field, and a universal signal (U-SIG) field which includes information necessary for interpreting the ELR PPDU,
wherein the L-SIG field, the RL-SIG field, and the U-SIG field are generated based on a first subcarrier frequency spacing,
wherein the ELR PPDU further includes a short training field (STF), a long training field (LTF), an ELR signal (ELR-SIG) field, and a data field,
wherein the STF, the LTF, the ELR-SIG field, and the data field are generated based on a second subcarrier frequency spacing,
wherein the ELR-SIG field is transmitted through four 52-tone resource units (RUs) duplicated in units of 52-tone RUs in frequency domain.

2. The method of claim 1, wherein the ELR PPDU has a bandwidth of 20 MHz.

3. The method of claim 1, wherein the RL-SIG field is contiguous to the L-SIG field, and the U-SIG field is contiguous to the RL-SIG field.

4. The method of claim 1, wherein the LTF is contiguous to the STF, and the ELR-SIG field is contiguous to the LTF.

5. The method of claim 1, wherein the first subcarrier frequency spacing is four times the second subcarrier frequency spacing.

6. The method of claim 1, wherein the ELR-SIG field includes additional information for interpreting the ELR PPDU, and the additional information includes information related to the Modulation and Coding Scheme (MCS) of the data field.

7. The method of claim 1, wherein the data field is transmitted in frequency domain in units of 52-tone resource units (RUs) via four duplicated 52-tone RUs.

8. The method of claim 1, wherein the ELR PPDU is transmitted based on a single spatial stream.

9. A station (STA), comprising:
at least one processor; and
at least one computer memory operatively connected to the at least one processor and storing instructions that, based on being executed by the at least one processor, perform operations comprising
generating an Enhanced Long Range (ELR) physical protocol data unit (PPDU); and
transmitting the ELR PPDU,
wherein the ELR PPDU includes a legacy signal (L-SIG) field, a repeated L-SIG (RL-SIG) which is a repeat of the L-SIG field, and a universal signal (U-SIG) field which includes information necessary for interpreting the ELR PPDU,
wherein the L-SIG field, the RL-SIG field, and the U-SIG field are generated based on a first subcarrier frequency spacing,
wherein the ELR PPDU further includes a short training field (STF), a long training field (LTF), an ELR signal (ELR-SIG) field, and a data field,
wherein the STF, the LTF, the ELR-SIG field, and the data field are generated based on a second subcarrier frequency spacing,
wherein the ELR-SIG field is transmitted through four 52-tone resource units (RUs) duplicated in units of 52-tone RUs in frequency domain.

10. A method, comprising;
receiving, by a station (STA), an Enhanced Long Range (ELR) physical protocol data unit (PPDU),
wherein the ELR PPDU includes a legacy signal (L-SIG) field, a repeated L-SIG (RL-SIG) which is a repeat of the L-SIG field, and a universal signal (U-SIG) field which includes information necessary for interpreting the ELR PPDU,
wherein the L-SIG field, the RL-SIG field, and the U-SIG field are generated based on a first subcarrier frequency spacing,
wherein the ELR PPDU further includes a short training field (STF), a long training field (LTF), an ELR signal (ELR-SIG) field, and a data field,
wherein the STF, the LTF, the ELR-SIG field, and the data field are generated based on a second subcarrier frequency spacing,
wherein the ELR-SIG field is received through four 52-tone resource units (RUs) duplicated in units of 52-tone RUs in frequency domain; and
decoding the ELR PPDU based on the U-SIG field and/or the EHT-SIG field.
